(19) United States
(12) Patent Application Publication
(10) Pub. No.: US 2017/0134126 A1
(43) Pub. Date: May 11, 2017

(54) SYSTEM AND METHOD FOR ENCODING AND DECODING HEADER DATA PORTION OF A FRAME

(71) Applicant: QUALCOMM Incorporated, San Diego, CA (US)

(72) Inventors: Amichai Sanderovich, Atlit (IL); Alecsander Eitan, Haifa (IL); Gal Basson, Haifa (IL)

(21) Appl. No.: 15/342,788

(22) Filed: Nov. 3, 2016

Related U.S. Application Data
(60) Provisional application No. 62/252,378, filed on Nov. 6, 2015.
(60) Provisional application No. 62/254,121, filed on Nov. 11, 2015.

(51) Int. Cl. H04L 5/00; H04L 27/18; H04W 72/04

(52) U.S. Cl. CPC H04L 5/0044; H04W 72/0446; H04L 27/18

(57) ABSTRACT

Apparatus for generating a header of a transmit frame, and for processing the header of a received frame. The header generating includes encoding header data bits to generate parity bits, repeating the header bits M times, repeating the parity bits N times, encoding the M repetitions of the header bits, encoding the N repetitions of the parity bits, combining the encoded M repetitions of the header bits with the N repetitions of the parity bits, and modulating the combined sequence to generate the header of the frame. The header processing includes demodulating the header to generate a sequence of bits, splitting the sequence into separate header and parity sequences, decoding the header and parity sequences to generate M header and N parity sequences, combining the M header sequences, combining the N parity sequences, and decoding the combined header sequences using the combined parity sequences to generate header data bits.

### CROSS-REFERENCE TO RELATED APPLICATIONS

This application claims the benefit of the filing dates of U.S. Provisional Application, Ser. No. 62/254,121, filed on Nov. 11, 2015, entitled, “System and Method for Encoding and Decoding Header Data Portion of a frame,” and U.S. Provisional Application, Ser. No. 62/252,378, filed on Nov. 6, 2015, entitled, “System and Method for Encoding and Decoding Header Data Portion of a frame,” both of which are incorporated herein by reference.

### FIELD

Certain aspects of the present disclosure generally relate to wireless communications and, more particularly, to system and method for encoding and decoding a header data portion of a frame.

### BACKGROUND

A new protocol under the Institute of Electrical and Electronic Engineers (IEEE) 802.11, tentatively identified as IEEE 802.1 lay, is being developed to increase data throughput through the use of a newly designed frame. An objective of the new protocol is to provide backwards compatibility with protocol 802.11ad. That is, devices operating under 802.11ad may be able to decode a portion of a frame in accordance with the proposed new protocol.

Accordingly, it is proposed that a frame according to the proposed new protocol includes at least a portion of the 802.11ad frame, such as the preamble (short training field (STF) and channel estimation sequence (CES)) and an 802.11ad header. A device operating under 802.11ad may be able to decode the 802.11ad portion of the frame according to the proposed new protocol to determine a duration of the frame (e.g., calculate a network allocation vector (NAV)) so that the device knows when the communication channel may be available.

The frame in accordance with the proposed new protocol is configured for higher data throughput than the frame in accordance with 802.11ad. For instance, modulation schemes with greater number of constellations may be available. Also, a frame may be transmitted via a bonded channel having a frequency bandwidth that spans the bandwidths of two or more channels pursuant to 802.11ad. Because of the additional features, the frame in accordance with the proposed new protocol includes its own header, tentatively referred to as Extended Directional Multigigabit (EDMG) Header, for providing information regarding the parameters of the frame.

As discussed, a frame in accordance with the proposed new protocol includes additional features that facilitate higher data throughputs. At least one of such feature is applicable to the EDMG Header of the frame. That is, in accordance with the proposed new protocol, quadrature phase shift keying (QPSK) modulation may be available for transmitting the EDMG Header of the frame. Because a receiving device generally needs to decode the header of a frame to decode other portions of the frame (e.g., the data payload portion), it is desirable to configure the header portion of the frame for higher reliability in the decoding of the header portion by a receiving device.

### SUMMARY

Certain aspects of the present disclosure provide an apparatus for wireless communications. The apparatus comprises a processing system configured to generate a plurality of parity bits by at least encoding a plurality of data bits; generate a first sequence of bits comprising M repetitions of the data bits; generate a second sequence of bits comprising N repetitions of the parity bits; generate a third sequence of bits based on the first and second sequences of bits; generate a sequence of modulation symbols based on the third sequence of bits; and generate a frame comprising the sequence of modulation symbols. The apparatus further comprises an interface configured to output the frame for transmission.

Certain aspects of the present disclosure provide a method for wireless communications. The method comprises generating a plurality of parity bits by at least encoding a plurality of data bits; generating a first sequence of bits comprising M repetitions of the data bits; generating a second sequence of bits comprising N repetitions of the parity bits; generating a third sequence of bits based on the first and second sequences of bits; generating a sequence of modulation symbols based on the third sequence of bits; generating a frame comprising the sequence of modulation symbols; and outputting the frame for transmission.

Certain aspects of the present disclosure provide an apparatus for wireless communications. The apparatus comprises means for generating a plurality of parity bits comprising means for encoding a plurality of data bits; means for generating a first sequence of bits comprising M repetitions of the data bits; means for generating a second sequence of bits comprising N repetitions of the parity bits; means for generating a third sequence of bits based on the first and second sequences of bits; means for generating a sequence of modulation symbols based on the third sequence of bits; means for generating a frame comprising the sequence of modulation symbols; and means for outputting the frame for transmission.

Certain aspects of the present disclosure provide a computer readable medium having instructions stored thereon for generating a plurality of parity bits by at least encoding a plurality of data bits; generating a first sequence of bits comprising M repetitions of the data bits; generating a second sequence of bits comprising N repetitions of the parity bits; generating a third sequence of bits based on the first and second sequences of bits; generating a sequence of modulation symbols based on the third sequence of bits; generating a frame comprising the sequence of modulation symbols; and outputting the frame for transmission.

Certain aspects of the present disclosure provide a wireless node. The wireless node comprises at least one antenna. The wireless node further comprises a processing system configured to: generate a plurality of parity bits by at least encoding a plurality of data bits; generate a first sequence of bits comprising M repetitions of the data bits; generate a second sequence of bits comprising N repetitions of the parity bits; generate a third sequence of bits based on the first and second sequences of bits; generate a sequence of modulation symbols based on the third sequence of bits; and generate a frame comprising the sequence of modulation symbols. Additionally, the wireless node further comprises an interface configured to output the frame for transmission.

Certain aspects of the present disclosure provide an apparatus for wireless communications. The apparatus comprises a processing system configured to receive a receive a frame comprising a sequence of modulation symbols; generate a first sequence of bits based on the sequence of modulation symbols; generate M sequences of bits based on the first sequence of bits; generate N sequences of bits based on the first sequence of bits; generate a second sequence of bits based on the M sequences of bits; generate a third sequence of bits based on the N sequences of bits; generate data bits by at least decoding the second sequence of bits based at least on the third sequence of bits.

Certain aspects of the present disclosure provide a method for wireless communications. The method comprises receiving a frame comprising a sequence of modulation symbols; generating M sequences of bits based on the first sequence of bits; generating N sequences of bits based on the first sequence of bits; generating a second sequence of bits based on the M sequences of bits; generating a third sequence of bits based on the N sequences of bits; and generating data bits by at least decoding the second sequence of bits based at least on the third sequence of bits.

Certain aspects of the present disclosure provide an apparatus for wireless communications. The apparatus comprises means for receiving a frame comprising a sequence of modulation symbols; means for generating a first sequence of bits based on the sequence of modulation symbols; means for generating M sequences of bits based on the first sequence of bits; means for generating N sequences of bits based on the first sequence of bits; means for generating a second sequence of bits based on the M sequences of bits; means for generating a third sequence of bits based on the N sequences of bits; and means for generating data bits by at least decoding the second sequence of bits based at least on the third sequence of bits.

Certain aspects of the present disclosure provide a computer readable medium having instructions stored thereon for receiving a frame comprising a sequence of modulation symbols; generating a first sequence of bits based on the sequence of modulation symbols; generating M sequences of bits based on the first sequence of bits; generating N sequences of bits based on the first sequence of bits; generating a second sequence of bits based on the M sequences of bits; generating a third sequence of bits based on the N sequences of bits; and generating data bits by at least decoding the second sequence of bits based at least on the third sequence of bits.

Certain aspects of the present disclosure provide a wireless node. The wireless node comprises at least one antenna. The wireless node further comprises a processing system configured to: receive a frame comprising a sequence of modulation symbols via the at least one antenna; generate a first sequence of bits based on the sequence of modulation symbols; generate M sequences of bits based on the first sequence of bits; generate N sequences of bits based on the first sequence of bits; generate a second sequence of bits based on the M sequences of bits; generate a third sequence of bits based on the N sequences of bits; and generate data bits by at least decoding the second sequence of bits based at least on the third sequence of bits.

Aspects of the present disclosure also provide various methods, means, and computer program products corresponding to the apparatuses and operations described above.

### BRIEF DESCRIPTION OF THE DRAWINGS

FIG. 1 is a diagram of an exemplary wireless communications network in accordance with certain aspects of the present disclosure.

FIG. 2 is a block diagram of an exemplary pair of wireless nodes in communication with each other in accordance with certain aspects of the present disclosure.

FIG. 3A illustrates an exemplary frame or frame portion in accordance with certain aspects of the present disclosure.

FIG. 3B illustrates an exemplary Extended Directional Multigigabit (EDMG) Header in accordance with certain aspects of the present disclosure.

FIG. 4 illustrates a diagram of an exemplary apparatus for encoding header bits for transmission via a frame in accordance with certain aspects of the present disclosure.

FIG. 5 illustrates a diagram of an exemplary apparatus for decoding a header portion of a received frame in accordance with certain aspects of the present disclosure.

FIGS. 6A-6D illustrate a set of exemplary frames for transmission of data via an orthogonal frequency division multiplexing (OFDM) transmission in accordance with certain aspects of the present disclosure.

FIGS. 7A-7C illustrate another set of exemplary frames for transmission of data via an orthogonal frequency division multiplexing (OFDM) transmission in accordance with certain aspects of the present disclosure.

FIGS. 8A-8C illustrate yet another set of exemplary frames for transmission of data via an orthogonal frequency division multiplexing (OFDM) transmission in accordance with certain aspects of the present disclosure.

FIGS. 9A-9C illustrate a set of exemplary frames for transmission of data via a single carrier wideband (SC WB) transmission in accordance with certain aspects of the present disclosure.

FIG. 9D illustrates an exemplary transmission power profile associated with the set of exemplary frames of FIGS. 9A-9C in accordance with certain aspects of the present disclosure.

FIGS. 10A-10C illustrate another set of exemplary frames for transmission of data via a single carrier wideband (SC WB) transmission in accordance with certain aspects of the present disclosure.

FIG. 10D illustrates an exemplary transmission power profile associated with the set of exemplary frames of FIGS. 10A-10C in accordance with certain aspects of the present disclosure.

FIGS. 11A-11C illustrate yet another set of exemplary frames for transmission of data via a single carrier wideband (SC WB) transmission in accordance with certain aspects of the present disclosure.

FIG. 11D illustrates an exemplary transmission power profile associated with the set of exemplary frames of FIGS. 11A-11C in accordance with certain aspects of the present disclosure.

FIGS. 12A-12D illustrate exemplary frames for transmission of short messages in accordance with another aspect of the disclosure.

FIGS. 13A-13D illustrate exemplary frames for transmission of data via an aggregated single carrier (SC) transmission in accordance with certain aspects of the present disclosure.

FIG. 14 illustrates an exemplary frame for transmission of data via a plurality (e.g., three (3)) of spatial multiple input multiple output (MIMO) orthogonal frequency division multiplexing (OFDM) transmissions in accordance with certain aspects of the present disclosure.

FIGS. 15A-15C illustrate exemplary frames for transmission of data via a plurality (e.g., two (2), four (4), and eight (8)) of spatial multiple input multiple output (MIMO) single carrier wideband (SC WB) transmissions in accordance with certain aspects of the present disclosure.

FIGS. 16A-16B illustrate exemplary frames for transmission of data via a plurality (e.g., two (2) and three (3)) of spatial multiple input multiple output (MIMO) aggregated single carrier (SC) transmissions in accordance with certain aspects of the present disclosure.

FIG. 17 illustrates a block diagram of an exemplary device in accordance with certain aspects of the present disclosure.

### DETAILED DESCRIPTION

Aspects of the present disclosure provide techniques for performing channel estimation of a bonded channel formed by bonding a plurality of channels by using channel estimation training sequences transmitted in each of the plurality of channels.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

With reference to the following description, it shall be understood that not only communications between access points and user devices are allowed, but also direct (e.g., peer-to-peer) communications between respective user devices are allowed. Furthermore, a device (e.g., an access point or user device) may change its behavior between a user device and an access point according to various conditions. Also, one physical device may play multiple roles: user device and access point, multiple user devices, multiple access points, for example, on different channels, different time slots, or both.

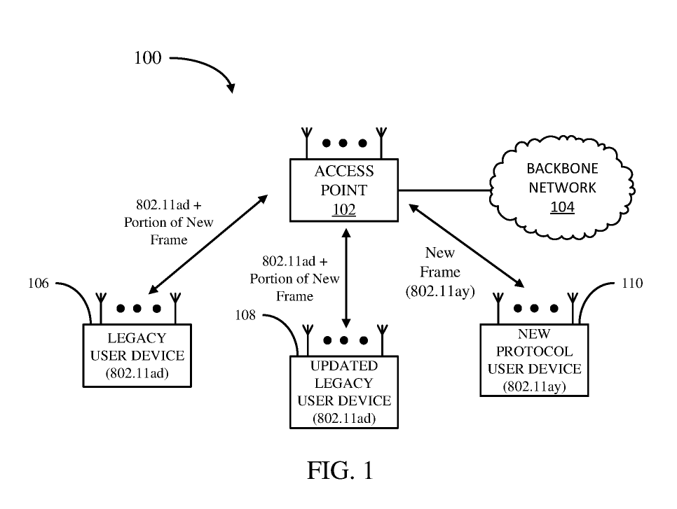

FIG. 1 is a diagram of an exemplary wireless communication network 100 in accordance with certain aspects of the present disclosure. The communication network 100 comprises an access point 102, a backbone network 104, a legacy user device 106, an updated legacy user device 108, and a new protocol user device 110.

The access point 102, which may be configured for a wireless local area network (LAN) application, may facilitate data communications between the user devices 106, 108, and 110. The access point 102 may further facilitate data communications between devices coupled to the backbone network 104 and any one or more of the legacy user device 106, updated legacy user device 108, and new protocol user device 110.

In this example, the access point 102 and the legacy user device 106 data communicate between each other using a legacy protocol. One example of a legacy protocol includes IEEE 802.11ad. According to this protocol, data communications between the access point 102 and the legacy user device 106 are effectuated via transmission of data frames that comply with the 802.11ad protocol. As discussed further herein, an 802.11ad data frame includes a preamble consisting of a legacy short training field (L-STF) and a legacy channel estimation sequence (L-CES), a legacy header (L-Header), a data payload, and an optional beamforming training field.

The L-STF sequence includes a plurality of Golay sequences (Ga₁₂₈) and a negative Golay sequence (−Ga₁₂₈) to signify the end of the L-STF sequence. The L-STF sequence may assist a receiver in setting up its automatic gain control (AGC), timing, and frequency setup for accurately receiving the rest of the frame and subsequent frames. In the case of a single carrier (SC) transmission mode, the L-CES sequence includes a Gu₅₁₂ sequence (consisting of the following concatenated Golay sequences (−Gb₁₂₈, −Ga₁₂₈, Gb₁₂₈, −Ga₁₂₈) followed by a Gv₅₁₂ sequence (consisting of the following concatenated Golay sequences (−Gb₁₂₈, Ga₁₂₈, −Gb₁₂₈, −Ga₁₂₈), and ending with a Gv₁₂₈ (same as −Gb₁₂₈) sequence. In the case of an orthogonal frequency division multiplexing (OFDM) transmission mode, the L-CES sequence includes a Gv₅₁₂ sequence followed by a Gu₅₁₂ sequence, and ending with a Gv₁₂₈ sequence. The L-CES sequence assists the receiver in estimating the channel frequency response and performing equalization to more reliably receive the frame.

The L-Header includes various information about the frame. Such information includes a scrambler initiation field, which specifies a seed for the scrambling applied to the remainder of the L-Header and the data payload for data whitening purposes. The L-Header also includes the modulation and coding scheme (MCS) field to indicate one out of 12 defined MCS used for transmitting the data payload of the frame. The L-Header includes a length field to indicate the length of the data payload in octets. The L-Header further includes a training length field to indicate a length of the optional beam forming training sequence at the end of the frame. Additionally, the L-Header includes a packet type field to indicate whether the optional beam forming field pertains to transmission or reception. Further, the L-Header includes an HCS field to indicate a CRC-32 checksum over the header bits.

Referring again to FIG. 1, the legacy user device 106 is capable of decoding the entire 802.11ad data frame. The new frame disclosed herein, which may be subsequently adopted for the new standard or protocol 802.11ay, provides some backward compatibility features. As discussed in more detail herein, the new frame includes the preamble (L-STF and L-CES) and the L-Header of the 802.11ad, and one or more additional portions pertaining to the new protocol. Accordingly, the legacy user device 106 is configured to decode the 802.11ad preamble (L-STF and L-CES) and L-Header portion of the new frame, but is not configured to decode the remaining portion of the new frame. The legacy user device 106 may decode the 802.11ad preamble and header portion of the new frame in order to calculate a network allocation vector (NAV) to determine the length of the new frame for transmission collision avoidance purposes.

The updated legacy user device 108 also operates under the legacy 802.11ad protocol, and is able to communicate with the access point 102 using 802.11ad data frames. However, the frame processing capability of the updated legacy user device 108 has been updated to interpret certain bits in the L-Header of the new frame that indicate an attribute of the new frame, as discussed further herein. In accordance with the legacy 802.11ad protocol, these bits are allocated to least significant bits (LSB) of the data length in the L-Header. But, in accordance with the new frame, the otherwise allocated bits of the L-Header are used to indicate a transmission power difference between a first portion of the new frame and a second portion of the new frame in accordance with a certain transmission mode associated with the new frame. These bits allow the updated legacy user device to anticipate the power difference (an increase) for signal interference management purposes. Although, in this example, the allocation of the LSB length bits signifies the aforementioned power difference, it shall be understood that these bits may be allocated for other purposes.

The new protocol user device 110 is capable of communicating with the access point 102 using the new data frame, which some or all features of the new frame may be adopted for the 802.11ay protocol. As discussed further herein, the new data frame includes the legacy 802.11ad preamble (L-STF and L-CES) and L-Header, with the L-Header slightly modified to indicate the transmission mode associated with the new frame and, as previously discussed, a transmission power difference between a first portion of the new frame and a second portion of the new frame. The slight modification to the L-Header of the new frame does not impact the decoding of the L-Header by the legacy user device 106 and the updated legacy user device 108. The bits in the L-Header of the new frame that indicate the transmission mode are reserved bits in the standard 802.11ad legacy header.

In addition to the legacy preamble (L-STF and L-CES) and L-Header, the new frame further comprises an Extended Directional Multigigabit (EDMG) Header. As discussed in more detail herein, the EDMG Header comprises a plurality of fields for indicating various attributes of the new frame. Such attributes includes payload data length, number of low density parity check (LDPC) data blocks in the EDMG Header, the number of spatial streams supported, the number of bonded channels, the leftmost (lowest frequency) channel of the bonded channels, the MCS used for the data payload of the new frame, the transmit power difference between different portions of the frame, and other information. The EDMG Header may further be appended with payload data that is not in the data payload portion of the new frame. For short messages, all of the payload data may be appended to the EDMG Header, thereby avoiding the need for transmitting the “separate” data payload portion of the new frame, which adds significant overhead to the frame.

The new data frame is configured to provide additional features to improve data throughput by employing higher data modulation schemes, channel bonding, channel aggregation, and improved spatial transmission via multiple input multiple output (MIMO) antenna configurations. For instance, the legacy 802.11ad protocol includes BPSK, QPSK, and 16QAM available modulation schemes. According to the new protocol, higher modulation schemes, such as 64QAM, 64APSK, 128APSK, 256QAM, and 256APSK are available. Additionally, a plurality of channels may be bonded or aggregated to increase data throughput. Further, such bonded or aggregated channels may be transmitted by way of a plurality of spatial transmissions using a MIMO antenna configuration.

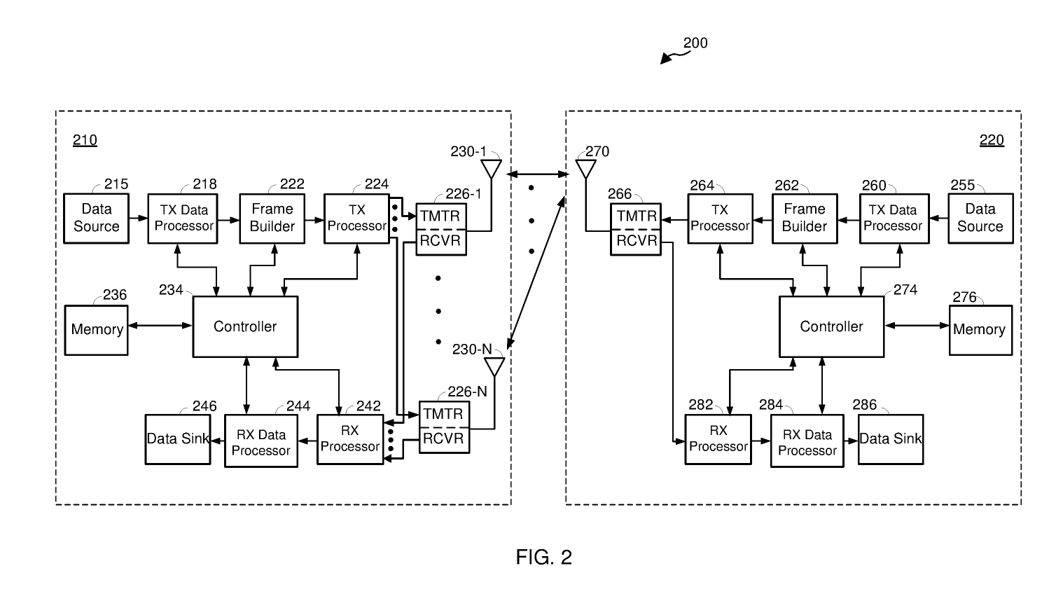

FIG. 2 illustrates a block diagram of an exemplary access point 210 (generally, a first wireless node) and an exemplary access terminal 220 (generally, a second wireless node) of a wireless communication system 200. The access point 210 is a transmitting entity for the downlink and a receiving entity for the uplink. The access terminal 220 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel.

It shall be understood that the access point 210 may alternatively be an access terminal, and the access terminal 220 may alternatively be an access point.

For transmitting data, the access point 210 comprises a transmit data processor 218, a frame builder 222, a transmit processor 224, a plurality of transceivers 226-1 to 226-N, and a plurality of antennas 230-1 to 230-N. The access point 210 also comprises a controller 234 for controlling operations of the access point 210.

In operation, the transmit data processor 218 receives data (e.g., data bits) from a data source 215, and processes the data for transmission. For example, the transmit data processor 218 may encode the data (e.g., data bits) into encoded data, and modulate the encoded data into data modulation symbols. The transmit data processor 218 may support different modulation and coding schemes (MCSs). For example, the transmit data processor 218 may encode data (e.g., using low density parity check (LDPC) encoding) at any one of a plurality of different coding rates. Also, the transmit data processor 218 may modulate the encoded data using any one of a plurality of different modulation schemes, including, but not limited to, BPSK, QPSK, 16QAM, 64QAM, 64APSK, 128APSK, 256QAM, and 256APSK.

In certain aspects, the controller 234 may send a command to the transmit data processor 218 specifying which modulation and coding scheme (MCS) to use (e.g., based on channel conditions of the downlink), and the transmit data processor 218 may encode and modulate data from the data source 215 according to the specified MCS. It is to be appreciated that the transmit data processor 218 may perform additional processing on the data such as data scrambling, interleaving, additional encoding, such as encryption, and/or other processing. The transmit data processor 218 outputs the data modulation symbols to the frame builder 222.

The frame builder 222 constructs a frame (also referred to as a packet), and inserts the data modulation symbols into header and data payload portions of the frame. The frame may include a preamble, an L-Header, an EDMG header, data payload, and other fields. The preamble may include a short training field (L-STF) sequence and a channel estimation sequence (L-CES) to assist the access terminal 220 in receiving the frame. The L-Header and/or the EDMG Header may include information related to the data in the payload such as the length of the data and the MCS used to encode and modulate the data. This information allows the access terminal 220 to demodulate and decode the data. The data in the payload may be divided among a plurality of blocks, wherein each block may include a portion of the data and a guard interval (GI) to assist the receiver with phase tracking. The frame builder 222 outputs the frame to the transmit processor 224.

The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode. The transmit processor 224 may apply a spectrum mask to the frame so that the frequency constituent of the downlink signal meets certain spectral requirements.

In certain aspects, the transmit processor 224 may support multiple-output-multiple-input (MIMO) transmission. In these aspects, the access point 210 may include multiple antennas 230-1 to 230-N and multiple transceivers 226-1 to 226-N (e.g., one for each antenna). The transmit processor 224 may perform spatial processing on the incoming frames and provide a plurality of transmit frame streams for the plurality of antennas. The transceivers 226-1 to 226-N receive and processes (e.g., converts to analog, amplifies, filters, and frequency upconverts) the respective transmit frame streams to generate transmit signals for transmission via the antennas 230-1 to 230-N, respectively.

For transmitting data, the access terminal 220 comprises a transmit data processor 260, a frame builder 262, a transmit processor 264, a transceiver 266, and one or more antennas 270 (for simplicity one antenna is shown). The access terminal 220 may transmit data to the access point 210 on the uplink, and/or transmit data to another access terminal (e.g., for peer-to-peer communication). The access terminal 220 also comprises a controller 274 for controlling operations of the access terminal 220.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data modulation symbols to the frame builder 262.

The frame builder 262 constructs a frame, and inserts the received data modulation symbols into header and data payload portions of the frame. The frame may include a preamble, header, and the data payload. The preamble may include an L-STF sequence and an L-CES sequence to assist the access point 210 and/or other access terminal in receiving the frame. The header may include information related to the data in the payload such as the length of the data and the MCS used to encode and modulate the data. The data in the payload may be divided among a plurality of blocks where each block may include a portion of the data and a guard interval (GI) assisting the access point and/or other access terminal with phase tracking. The frame builder 262 outputs the frame to the transmit processor 264.

The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode. The transmit processor 264 may apply a spectrum mask to the frame so that the frequency constituent of the uplink signal meets certain spectral requirements.

The transceiver 266 receives and processes (e.g., converts to analog, amplifies, filters, and frequency upconverts) the output of the transmit processor 264 for transmission via the one or more antennas 270. For example, the transceiver 266 may upconvert the output of the transmit processor 264 to a transmit signal having a frequency in the 60 GHz range.

In certain aspects, the transmit processor 264 may support multiple-output-multiple-input (MIMO) transmission. In these aspects, the access terminal 220 may include multiple antennas and multiple transceivers (e.g., one for each antenna). The transmit processor 264 may perform spatial processing on the incoming frame and provide a plurality of transmit frame streams for the plurality of antennas. The transceivers receive and processes (e.g., converts to analog, amplifies, filters, and frequency upconverts) the respective transmit frame streams to generate transmit signals for transmission via the antennas.

For receiving data, the access point 210 comprises a receive processor 242, and a receive data processor 244. In operation, the transceivers 226-1 to 226-N receive a signal (e.g., from the access terminal 220), and spatially process (e.g., frequency downconverts, amplifies, filters and converts to digital) the received signal.

The receive processor 242 receives the outputs of the transceivers 226-1 to 226-N, and processes the outputs to recover data or modulation symbols. For example, the access point 210 may receive data (e.g., from the access terminal 220) in a frame. In this example, the receive processor 242 may detect the start of the frame using the L-STF sequence in the preamble of the frame. The receive processor 242 may also use the L-STF for automatic gain control (AGC) adjustment. The receive processor 242 may also perform channel estimation (e.g., using the L-CES sequence in the preamble of the frame) and perform channel equalization on the received signal based on the channel estimation.

Further, the receive processor 242 may estimate phase noise using the guard intervals (GIs) in the payload, and reduce the phase noise in the received signal based on the estimated phase noise. The phase noise may be due to noise from a local oscillator in the access terminal 220 and/or noise from a local oscillator in the access point 210 used for frequency conversion. The phase noise may also include noise from the channel. The receive processor 242 may also decode header data modulation symbols (e.g., based on the MCS scheme) from the header portion of the frame, and send the decoded header information to the controller 234. After performing channel equalization and/or phase noise reduction, the receive processor 242 may recover payload data modulation symbols from the frame, and output the recovered payload data modulation symbols to the receive data processor 244 for further processing.

The receive data processor 244 receives the payload data modulation symbols from the receive processor 242 and an indication of the corresponding MSC scheme from the controller 234. The receive data processor 244 demodulates and decodes the payload data symbols to recover the payload data according to the indicated MSC scheme, and outputs the recovered payload data (e.g., data bits) to a data sink 246 for storage and/or further processing.

As discussed above, the access terminal 220 may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the access point 210 includes multiple antennas 230-1 to 230-N and multiple transceivers 226-1 to 226-N (e.g., one for each antenna). Each transceiver receives and processes (e.g., frequency downconverts, amplifies, filters, and converts to digital) the signal from the respective antenna. The receive processor 242 may perform spatial processing on the outputs of the transceivers 226-1 to 226-N to recover the data modulation symbols.

For receiving data, the access terminal 220 comprises a receive processor 282, and a receive data processor 284. In operation, the transceiver 266 receives a signal (e.g., from the access point 210 or another access terminal), and processes (e.g., frequency downconverts, amplifies, filters and converts to digital) the received signal.

The receive processor 282 receives the output of the transceiver 266, and processes the output to recover data modulation symbols. For example, the access terminal 220 may receive data (e.g., from the access point 210 or another access terminal) in a frame, as discussed above. In this example, the receive processor 282 may detect the start of the frame using the L-STF sequence in the preamble of the frame. The receive processor 282 may also perform channel estimation (e.g., using the L-CES sequence in the preamble of the frame) and perform channel equalization on the received signal based on the channel estimation.

Further, the receive processor 282 may estimate phase noise using the guard intervals (GIs) in the payload, and reduce the phase noise in the received signal based on the estimated phase noise. The receive processor 282 may also decode header data modulation symbols (e.g., via an MCS scheme) from the header portion of the frame, and send the header information to the controller 274. After performing channel equalization and/or phase noise reduction, the receive processor 282 may recover payload data modulation symbols from the frame, and output the recovered payload data modulation symbols to the receive data processor 284 for further processing.

The receive data processor 284 receives the payload data modulation symbols from the receive processor 282 and an indication of the corresponding MSC scheme from the controller 274. The receive data processor 284 demodulates and decodes the payload data modulation symbols to recover the payload data according to the indicated MSC scheme, and outputs the recovered payload data (e.g., data bits) to a data sink 286 for storage and/or further processing.

As discussed above, the access point 210 or another access terminal may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 220 may include multiple antennas and multiple transceivers (e.g., one for each antenna). Each transceiver receives and processes (e.g., frequency downconverts, amplifies, filters, and converts to digital) the signal from the respective antenna. The receive processor 282 may perform spatial processing on the outputs of the transceivers to recover the data symbols.

As shown in FIG. 2, the access point 210 also comprises a memory 236 coupled to the controller 234. The memory 236 may store instructions that, when executed by the controller 234, cause the controller 234 to perform one or more of the operations described herein. Similarly, the access terminal 220 also comprises a memory 276 coupled to the controller 274. The memory 276 may store instructions that, when executed by the controller 274, cause the controller 274 to perform the one or more of the operations described herein.

### Frame Format Common to the Enhanced Frames

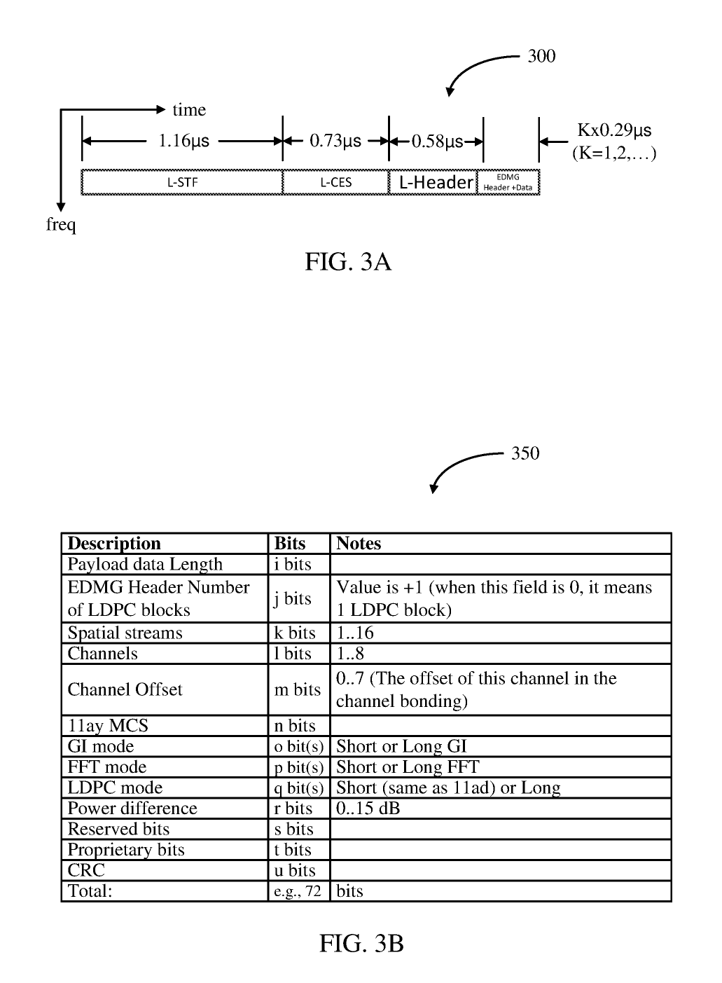

FIG. 3A illustrates an exemplary frame 300 (or portion thereof) in accordance with another aspect of the disclosure. As described herein, all of the suggested frame formats include legacy fields: L-STF+L-CES+L-Header. After the legacy fields, the transmission includes various fields that are part of the proposed new 802.11ay protocol or formats. According to the new protocol, several transmission options may be used: orthogonal frequency division multiplexing (OFDM), single carrier wideband (SC WB), single carrier (SC) Aggregate, and each one has various options and formats. All the aforementioned 802.11ay options include an EDMG Header with optional data.

As shown, according to the new frame or frame portion 300, the L-STF may have a duration of substantially 1.16 microseconds (ρs), the L-CES may have a duration of substantially 0.73 μs, the L-Header may have a duration of substantially 0.58 μs, and the EDMG Header may have a duration of substantially 0.29 μs or an integer K multiple thereof. In the case that the frame 300 is a full frame (not a frame portion), the frame 300 may be transmitted via a single channel and include data payload in the EDMG Header. Such configuration may be useful for short messages because there is no need for a separate data payload according to the new frame format, which may consume overhead for the transmission.

The L-Header specifies various parameters and it is decoded by all stations (user devices and access points) that are in range. These stations listen when they are waiting for receiving a message or prior to transmission. The L-Header specifies the modulation coding scheme (MCS) used in the legacy data transmission and the amount of data that is transmitted. Stations use these two values to compute the duration length to update the network allocation vector (NAV). This is a mechanism that allows stations to know that the medium is going to be used by a transmitter, even if they cannot decode the data itself, or even if they are not the intended receiver of the message. The use of NAV is one of the mechanisms to avoid transmitted signal collisions.

In the legacy 802.11ad frame format (for data), data is placed in low density parity check (LDPC) blocks, where the size is according to the code rate, then encoded to a fixed length (672 bits). The outcome is concatenated and then split into Fast Fourier Transform (FFT) blocks according to the selected MCS (mainly modulation). At a receiver, the process is reversed. It should be noted that in low data MCSs, one LDPC block may require one or more FFT blocks, while in high data MCSs, one FFT block may host more than one LDPC blocks. This discussion is relevant to the placing of LDPC data immediately after the EDMG Header.

FIG. 3B illustrates an exemplary EDMG Header 350 of the frame or frame portion 300 in accordance with certain aspects of the present disclosure. The EDMG Header 350 specifies the transmission frame parameters (MCS, Data length, modes, etc.) that are used by a receiver to be able to receive and decode the transmission frame. There is no need for other stations (not the destination station) to demodulate the EDMG Header 350. Hence, the EDMG Header 350 and optional attached data can be transmitted at high MCS that is suitable for the destination station.

The EDMG Header 350 comprises: (1) a Payload data Length field including “i” bits to specify the length of the new protocol 802.11ay payload data in octets in all concurrent channels, regardless of whether the payload data is appended to the EDMG Header or in the separate payload portion; (2) an EDMG Header Number of LDPC blocks field including “j” bits to specify the number of LDPC data blocks in the EDMG Header and data. When this value is zero (0), it means there is one (1) LDPC block of data in the EDMG Header; (3) a Spatial streams field including “k” bits to represent the number (e.g., 1 to 16) of spatial streams that are transmitted; (4) a Channels field including “1” bits to specify the number of bonded channels (e.g., 1 to 8 802.11ad channels, as well as additional channels not available in 802.11ad); and (5) a Channel offset field including “m” bits to specify the offset of the first channel of the bonded channels. In this example, the first channel is the left-most (lowest frequency) channel among the bonded channels. This value is set to zero (0) when the first channel is the lowest frequency channel among all the available channels, or when only one channel is used (i.e., no channel bonding).

The EDMG Header 350 further comprises: (6) an 11ay MCS field including “n” bits to specify the MCS used in the NG60 (802.11ay) data payload transmission. Note that the short data attached to EDMG Header uses the legacy 802.11ad MCS. The 802.11ay MCS may include higher throughput modulation schemes beyond those available in 802.11ad, such as 64QAM, 64APSK, 256QAM, and 256 APSK; (7) a GI (Guard Interval) mode field including “o” bit(s) to indicate short or long GI. Note that the actual values may be dependent on parameters, such as the number of bonded channels; (8) an FFT mode field including “p” bit(s) to indicate short or long FFT or FDE block. Note that the actual values may be dependent on parameters, such as the number of bonded channels; and (9) an LDPC mode field including “q” bit(s) to indicate short or long LDPC block.

The EDMG Header 350 further comprises: (10) a Power difference field including “r” bits to signal a difference in average power between the aggregated power of the legacy portion and EDMG Header of the new frame (e.g., L-STF+L-CES+L-Header+EDMG Header/Data) and the SC WB mode transmission of the NG60 (802.11ay) part (optional NG60 STF+optional NG60 CES+separate NG60 Payload). This difference may be vendor specific. Some transmitters may need power backoff between the aggregated section and the WB section due to PA non-linearity. This value informs the receiver about the expected power difference to assist in AGC setup. The value is coded in dB (e.g., 0000: 0 dB, 0100: 4 dB, 1111: 15 dB or above).

The EDMG Header 350 further comprises: (11) Reserved bits, that is, “s” bits that are reserved at this time. Transmitters should set them to 0 at this time. In the future, these bits may be allocated to various needs; (12) Proprietary bits, that is, “t” spare bits that may be used by vendors and do not require interoperability. Receivers should discard these bits unless they know what they are; and (13) a CRC field including “u” bits to sign the EDMG Header. This field is to be used by a receiver to validate the correctness of the received EDMG Header. All bits (except the CRC) shall be used to compute the CRC. The EDMG Header 350 may have a length of 72 bits. The EDMG Header 350 may be sent on each concurrently-transmitted channel with exactly the same content. This duplication may be used by a receiver to increase the correct detection probability. A receiver may use different algorithms: Option1: receiver decodes only one channel (simples but lowest performance); Option2: receiver decodes only one channel at the time. If CRC passes, then the receiver may cease CRC processing for additional channel(s), if it has not attempted CRC processing for additional channel(s). Option 2 may be better at performance than Option 1, but requires serial processing; and Option 3: receiver decodes all channels and selects one that has the corrected CRC. Option 3 may have the same performance as Option 2, but is faster.

### Encoding and Decoding the EDMG Header

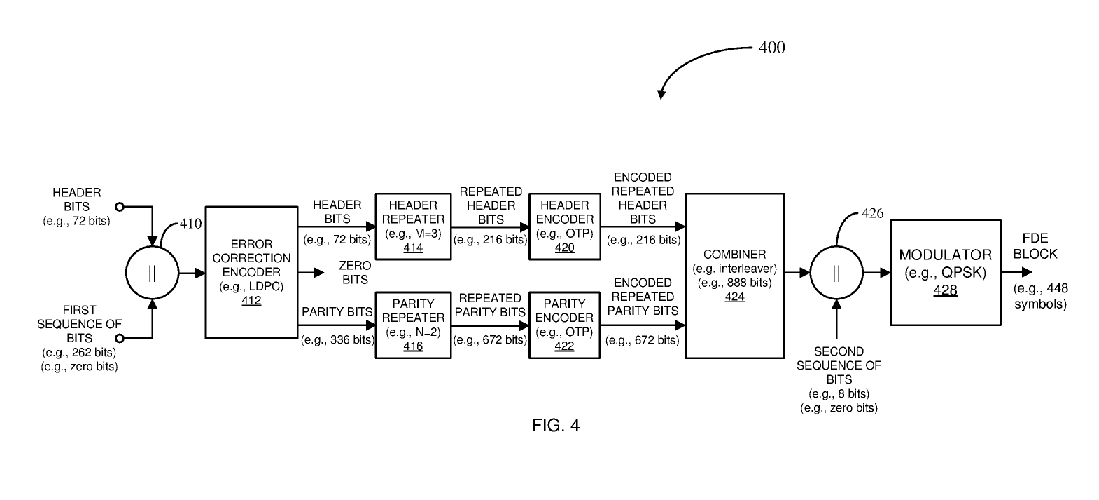

FIG. 4 illustrates a diagram of an exemplary apparatus 400 for encoding header bits for transmission via a frame in accordance with certain aspects of the present disclosure. In summary, the apparatus 400 is configured to process header data bits for transmission via a frame. The processing of the header data bits is performed in a manner that builds in significant redundancy in the header bits and associated parity bits to form the corresponding EDMG Header of the frame. The redundancy significantly improves the reliability in a receiving device successfully decoding the EDMG Header. As previously discussed, once the receiving device successfully decodes the EDMG Header, it may decode the remaining portion (e.g., the data payload) of the frame.

For illustration and explanation purposes, an EDMG Header with a length of 72 bits is provided as an input to the apparatus 400. It shall be understood that the EDMG Header may have a length of more or less than 72 bits. Also, for illustration and explanation purposes, a block of data modulation symbols, also referred herein as a Frequency Domain Equalization (FDE) block or FFT block, that includes all of the bits associated with the transmission of the EDMG Header data bits, has a length of 448 data modulation symbols. It shall be understood that the EDMG Header block of data modulation symbols may have a length of more or less than 448 symbols. Further, according to this example, QPSK modulation (including π/2-QPSK) is used to generate the block of 448 data modulation symbols. It shall be understood that other type of modulation may be used to generate the block of data modulation symbols.

Accordingly, the apparatus 400 is configured to generate the block of data modulation symbols such that substantially all of the data modulation symbols may be used by a receiving device in decoding the header portion of a frame. Since, in this example, there are only 72 header bits and 448 data modulation symbols, which translates to 896 bits, the apparatus 400 provides redundancy in the header bits and also to parity bits generated by encoding the header bits so that substantially all of the 448 data modulation symbols (in this example, 444 out of the 448 data modulation symbols) may be used by the receiver to decode the header portion of the frame.

In particular, the apparatus 400 includes an appending or concatenating device 410 configured to generate a sequence of bits by padding the 72 header bits with a first sequence of bits (e.g., 262 bits). The reason for this is that the error correction encoding used by the apparatus 400 uses an input data vector of 336 bits. Accordingly, the first sequence of bits appended by the appending or concatenating device 410 make up the deficiency in the number of header bits. The first sequence of bits may be dummy bits or contain no information. As a specific example, the first sequence of bits may consist of only zero bits. The first sequence of bits should be known by a receiving apparatus 500, discussed further herein. It shall be understood that if the apparatus 400 uses a different error correction encoding, the number of bits in the first sequence of bits appended to the header bits may be different. Further, it shall be understood that the header bits may have the same size as the input data vector for the error correction encoding used. In such a case, the apparatus 400 would not require the appending or concatenating device 410, and the header bits may be the only input for the error correction encoding.

The apparatus 400 further includes an error correction encoder 412 configured to encode the sequence of bits generated by the appending or concatenating device 410. In this example, the error correction encoder 412 performs low density parity check (LDPC) encoding of the sequence of bits generated by the appending or concatenating device 410. Further, according to this example, the code rate for the encoding is ½. It shall be understood that the error correction encoder 412 may use other types of error correction encoding, such as convolutional encoding, turbo encoding, and a code rate different than ½. As the error correction encoder 412 is a 336 bit encoder, and the code rate is ½, the error correction encoder 412 generates 336 parity bits in addition to the original 72 header bits and the 262 bits of the first sequence.

For building in additional redundancy and reliability in the header portion of the frame to be transmitted, the apparatus 400 includes a header repeater 414. The header repeater 414 is configured to generate a sequence of bits comprising a defined integer number M of repetitions of the header bits. In this example, the number M is three (3). Accordingly, as the number of header bits is 72 in this example, the sequence of bits generated by the header repeater 414 has a length of 216 bits (e.g., 3×72 bits). It shall be understood that the integer M may be different than three (3).

Similarly, for building in additional redundancy and reliability in the header portion of the frame to be transmitted, the apparatus 400 includes a parity repeater 416. The parity repeater 416 is configured to generate a sequence of bits comprising a defined integer number N of repetitions of the parity bits. In this example, the number N is two (2). Accordingly, as the number of parity bits is 336 in this example, the sequence of bits generated by the parity repeater 416 has a length of 672 bits (e.g., 2×336 bits). It shall be understood that the integer N may be different than two (2). Additionally, it shall be understood that the integer M (i.e., number of repetitions of the header bits) may be different or the same as integer N (i.e., number of repetitions of the parity bits).

For additional encoding or other purposes, the apparatus 400 includes a header encoder 420 configured to encode the sequence of bits generated by the header repeater 414. In this example, the header encoder 420 performs a one-time pad (OTP) encryption or scrambling of the sequence of bits generated by the header repeater 414. It shall be understood that the header encoder 420 may perform another type of encoding including encryption or scrambling of the sequence of bits generated by the header repeater 414. As the sequence of bits generated by the header repeater 414 has a length of 216 bits in this example, the header encoder 420 generates a sequence of encoded repeated header bits also with a length of 216 bits.

Similarly, for additional encoding or other purposes, the apparatus 400 includes a parity encoder 422 configured to encode the sequence of bits generated by the parity repeater 416. In this example, the parity encoder 422 performs a one-time pad (OTP) encryption or scrambling of the sequence of bits generated by the parity repeater 416. It shall be understood that the parity encoder 422 may perform another type of encoding including encryption or scrambling of the sequence of bits generated by the parity repeater 416. As the sequence of bits generated by the parity repeater 416 has a length of 672 bits in this example, the parity encoder 422 generates a sequence of encoded repeated parity bits with a length of 672 bits.

For the purpose of generating a single sequence for modulation purposes or other purposes, the apparatus 400 includes a combiner 424. The combiner 424 is configured to combine the sequence of encoded repeated header bits generated by the header encoder 420 with the sequence of encoded repeated parity bits generated by the parity encoder 422. In this example, the combiner 424 may be an interleaver configured to interleave the sequence of bits generated by the header encoder 420 with the sequence of bits generated by the parity encoder 422. It shall be understood that combiner 424 may combine the sequences of bits generated by the header encoder 420 and the parity encoder 422 in other manners to generate a single sequence of bits.

As the number of encoded repeated header bits is 216 and the number of encoded repeated parity bits is 672, the sequence of bits generated by the combiner 424 has a length of 888 bits (e.g., 216+672 bits). This number of bits (888) is close to the full number of bits of 896 for generating a desired size of 448 data modulation symbols in accordance with a QPSK modulation scheme. Thus, a general concept of the disclosure herein is to repeat the header bits (or more generally, data bits) and the parity bits in such a manner that the combined sequence of repeated header and parity bits substantially matches or gets as close to the number of bits corresponding to the desired size for the block of data modulation symbols associated with the header portion of the frame to be transmitted. In this example, the sequence of bits generated by the combiner 424 (e.g., 888 bits) falls eight (8) short of the 896 bits needed to generate the 448 data modulation symbols.

Accordingly, so that the size of the sequence of bits inputted into a QPSK modulator corresponds to the desired size of the sequence of data modulation symbols, the apparatus 400 includes another appending or concatenating device 426 configured to append a second sequence of bits (e.g., eight (8) bits) to the sequence of bits generated by the combiner 424. Generally, as the combination of repeated header bits and repeated parity bits may not match exactly or fall short of the number of input bits required by the modulator for the desired block size of data modulation symbols, the second sequence of bits appended by the appending or concatenating device 426 make up the deficiency. The second sequence of bits may be dummy bits or contain no information. As one example, the second sequence of bits may consist of only zero bits.

The apparatus 400 further comprises a modulator 428 configured to modulate the sequence of bits generated by the appending or concatenating device 426 to generate a block of data modulation symbols (e.g., an FDE block of data modulation symbols). Accordingly, per this example, the modulator 428 performs QPSK modulation (including π/2 QPSK modulation) of the sequence of 896 bits generated by the appending or concatenating device 426 to generate a block of 448 data modulation symbols. The modulator 428 provides the block or sequence of data modulation symbols to the frame builder 222 or 262. The frame builder 222 or 262 generates a frame including the block or sequence of data modulation symbols generated by the modulator 428 as, for example, the header portion of the frame. Accordingly, the functionality of the apparatus 400 may be implemented in the transmit data processor 218 or 260.

It shall be understood that the processing of the header bits by apparatus 400 as depicted may be performed in a different order or manner. As an example, the header encoder 420 may be positioned upstream of the header repeater 414 so that the header bits are first encoded (e.g., undergo one-time-pad (OTP) encryption or scrambling) by header encoder 420, and then the encoded header bits may be repeated M times by header repeater 414. Similarly, the parity encoder 422 may be positioned upstream of the parity repeater 416 so that the parity bits are first encoded (e.g., undergo one-time-pad (OTP) encryption or scrambling) by parity encoder 422, and then the encoded parity bits may be repeated N times by parity repeater 416. Further, it shall be understood that the header encoder 420 or parity encoder 422 may be positioned upstream of the header repeater 414 or parity repeater 416 in one of the signal paths, and positioned downstream of the header repeater 414 or parity repeater 416 in the other signal path.

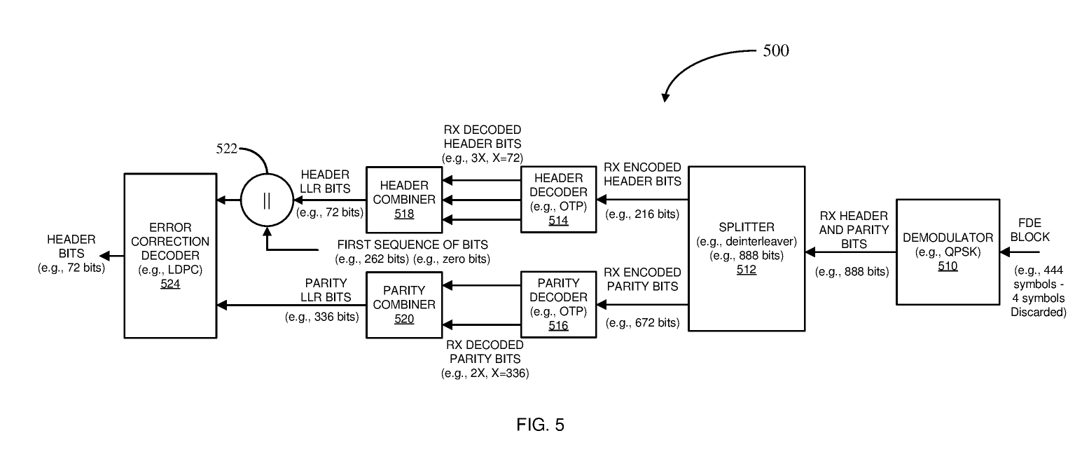

FIG. 5 illustrates a diagram of an exemplary apparatus 500 for decoding a header portion of a received frame in accordance with certain aspects of the present disclosure.

In summary, the apparatus 500: (1) decodes a sequence of data modulation symbols of a frame to generate a sequence of bits; (2) splits the sequence of bits into first (header-related) and second (parity-related) sequences of bits; (3) decodes the first (header-related) sequence of bits to generate M sequences of bits; (4) decodes the second (parity-related) sequence of bits to generate N sequences of bits; (5) combines the M sequences of bits to generate header-related log-likelihood ratio (LLR) bits; (6) combines the N sequences of bits to generate parity-related log-likelihood ratio (LLR) bits; (7) appends the first sequence of bits to the header-related log-likelihood ratio (LLR) bits to match the input data vector for an error correction decoder; and (8) decodes the header-related LLR bits appended with the first sequence of bits based on the parity-related LLR bits to generate the header data bits.

In particular, the apparatus 500 includes a demodulator 510 configured to receive at least a portion of a block or sequence of data modulation symbols (e.g., an FDE or FFT block of data modulation symbols) of a received frame. The sequence of data modulation symbols may be associated with a header portion of the received frame. As discussed above with regard to the apparatus 400, the sequence of data modulation symbols may be of a certain desired size, such as, for example, 448 modulation symbols. Also, as discussed, not all of the data modulation symbols in the block may be contain information related to header information. As discussed in apparatus 400, the second sequence of bits may have been appended to the sequence of bits to achieve the desired size of the block of data modulation symbols. For example, in this case, eight (8) bits corresponding to four (4) modulation symbols have been added. Accordingly, the demodulator 510 may only receive the 444 data modulation symbols that contain header information and the padded four (4) modulation symbols may be discarded.

The demodulator 510 demodulates the received sequence of modulation symbols to generate a sequence of bits related to header and corresponding parity data of the header portion of the received frame. In this example, the demodulator 510 performs QPSK demodulation (including π/2-QPSK demodulation) to generate the sequence of bits. It shall be understood that the demodulator 510 may be configured to perform other types of demodulation, such as demodulation that involves more or less constellations than QPSK. As the received sequence of modulation symbols has a length of 448 symbols in this example, the demodulator generates a sequence of bits having a length of 888 bits.

The apparatus 500 further includes a splitter 512 configured to split the sequence of bits generated by the demodulator 510 into a first sequence of bits related to the header data bits of the received frame and a second sequence of bits related to the corresponding parity bits of the received frame. In this example, the splitter 512 may be a deinterleaver configured to deinterleave the sequence of bits generated by the demodulator 510 into the header-related sequence of bits and the parity-related sequence of bits. It shall be understood that the splitter 512 may perform other types of bit sequence splitting. Further, in accordance with this example, the header-related sequence of bits may have a size of 216 bits (e.g., M×length of the header data bits, or specifically, 3×72 bits) and the parity-related sequence of bits may have a size of 672 bits (e.g., N×length of the parity bits, or specifically, 2×336 bits).

The apparatus 500 further includes a header decoder 514 configured to decode the header-related sequence of bits generated by the splitter 512. In this example, the header decoder 514 may perform one-time-pad (OTP) decryption or descrambling of the header-related sequence of bits generated by the splitter 512. It shall be understood that the header decoder 514 may perform another type of decoding of the header-related sequence of bits generated by the splitter 512. The header decoder 514 is configured to generate M sequences of decoded header-related bits. As, in this example, the sequence of header-related bits generated by the splitter 512 has a length of 216 bits, and M is three (3), the header decoder 514 generates three (3) sequences of decoded header-related bits, each having a length of 72 bits (e.g., the same length as the header data bits processed by apparatus 400).

Similarly, the apparatus 500 further includes a parity decoder 516 configured to decode the parity-related sequence of bits generated by the splitter 512. In this example, the parity decoder 516 may perform one-time-pad (OTP) decryption or descrambling of the parity-related sequence of bits generated by the splitter 512. It shall be understood that the parity decoder 516 may perform another type of decoding of the parity-related sequence of bits generated by the splitter 512. The parity decoder 516 is configured to generate N sequences of decoded parity-related bits. As, in this example, the sequence of parity-related bits generated by the splitter 512 has a length of 672 bits, and N is two (2), the parity decoder 516 generates two (2) sequences of decoded parity-related bits, each having a length of 336 bits (e.g., the same length as the parity bits generated by apparatus 400).

The apparatus 500 further includes a header combiner 518 configured to combine the M sequences of decoded header-related bits generated by the header decoder 514 to generate a sequence of header-related LLR bits. The header combiner 518 combines the M sequences in a substantially time-aligned bit manner, where the first bit of the sequences are combined together, the second bit of the sequences are combined together, and so on, until the last bit of the sequences are combined together. The header combiner 518 may perform a maximum ratio combining (MRC) of the M sequences of decoded header-related bits. According to MRC, the M sequences of header-related bits are combined in a manner that substantially maximizes the signal-to-noise ratio (SNR) of the generated sequence of header-related LLR bits. It shall be understood that the header combiner 518 may combine the M sequences of decoded header-related bits in other manners. As, in this example, each of the M sequences of decoded header-related bits has a length of 72 bits, the resulting sequence of header-related LLR bits generated by the header combiner 518 likewise has a length of 72 bits.

Similarly, the apparatus 500 further includes a parity combiner 520 configured to combine the N sequences of decoded parity-related bits generated by the parity decoder 516 to generate a sequence of parity-related LLR bits. The parity combiner 520 also combines the N sequences in a substantially time-aligned bit manner, where the first bit of the sequences are combined together, the second bit of the sequences are combined together, and so on, until the last bit of the sequences are combined together. The parity combiner 520 may perform a maximum ratio combining (MRC) of the N sequences of decoded parity-related bits. According to MRC, the N sequences of parity-related bits are combined in a manner that substantially maximizes the signal-to-noise ratio (SNR) of the generated sequence of parity-related LLR bits. It shall be understood that the parity combiner 520 may combine the N sequences of decoded parity-related bits in other manners. As, in this example, each of the N sequences of decoded parity-related bits has a length of 336 bits, the resulting sequence of parity-related LLR bits generated by the parity combiner 520 likewise has a length of 336 bits.

The apparatus 500 further comprises an appending or concatenating device 522 configured to generate a sequence of bits by padding the sequence of header LLR bits generated by the header combiner 518 with the same first sequence of bits applied to the appending or concatenating device 410 in the transmitting apparatus 400, as previously discussed. This is done so that the resulting sequence of bits generated by the appending or concatenating device 522 matches the size of the input data vector for error correction decoding. It shall be understood that if the length of the sequence of header LLR bits generated by the header combiner 518 matches the size of the input data vector for error correction decoding, the apparatus 500 need not include the appending or concatenating device 522. As, in this example, the size of the input data vector for error correction decoding is 336 bits, the appending or concatenating device 522 appends 262 bits to the header LLR bits to generate the resulting sequence of 336 LLR bits.

The apparatus 500 further includes an error correction decoder 524 configured to generate the header data bits by decoding the sequence of LLR data bits generated by the appending or concatenating device 522 based on the parity LLR bits generated by the parity combiner 520. In this example, the error correction decoder 524 performs LDPC decoding of the sequence of LLR data bits based on the sequence of parity LLR bits. In this example, the data rate of the LDPC decoding is ½. It shall be understood that the error correction decoder 524 may perform other types decoding, such as convolutional decoding, Turbo decoding, and the data rate may be different than ½. As, in this example, the original header data bits processed by the transmitting apparatus 400 has a length of 72 bits, the error correction decoder 524 generates the 72 bits of header data bits. The header data bits may be provided to the controller 234 or 274 to assist in the further demodulating and decoding of the data payload portion of the received frame, as previously discussed. Also, as discussed, the header data bits may pertain to the EDMG Header of the proposed new frame protocol under 802.11 ay.

It shall be understood that the processing of the received header-related and parity-related bits by apparatus 500 as depicted may be performed in a different order or manner. As an example, the header decoder 514 may be positioned downstream of the header combiner 518 so that the splitter 512 generates M sequences of encoded header-related bits, which are then combined (e.g., by MRC) by the header combiner 518, and then decoded (e.g., by undergoing one-time-pad (OTP) decryption or descrambling) by the header decoder 514 to generate the sequence of header LLR bits. Similarly, the parity decoder 516 may be positioned downstream of the parity combiner 520 so that the splitter 512 generates N sequences of encoded parity-related bits, which are then combined (e.g., by MRC) by the parity combiner 520, and then decoded (e.g., by undergoing one-time-pad (OTP) decryption or descrambling) by the parity decoder 516 to generate the sequence of parity LLR bits. Further, it shall be understood that the header decoder 514 or parity decoder 516 may be positioned downstream of the header combiner 518 or parity combiner 520 in one of the signal paths, and positioned upstream of the header combiner 518 or parity combiner 520 in the other signal path.

Thus, because of the redundancy in the header data bits and the corresponding parity bits embedded in the block of data modulation symbols of the received frame, the apparatus 500 is able to generate the header data bits in a significantly more reliable manner Additionally, as discussed with reference to apparatus 400, the redundancy of the header data bits and the parity bits is configured such that it makes substantially full use of the FDE or FFT block of data modulation symbols. In other words, substantially all of the data modulation symbols of the block contribute to the decoding of the header data bits by apparatus 500. The operation of the apparatus 500 may be implemented in the receive processor 242 or 282.

### Frame Format for OFDM with L-CES and CES-GF Transmitted Simultaneously

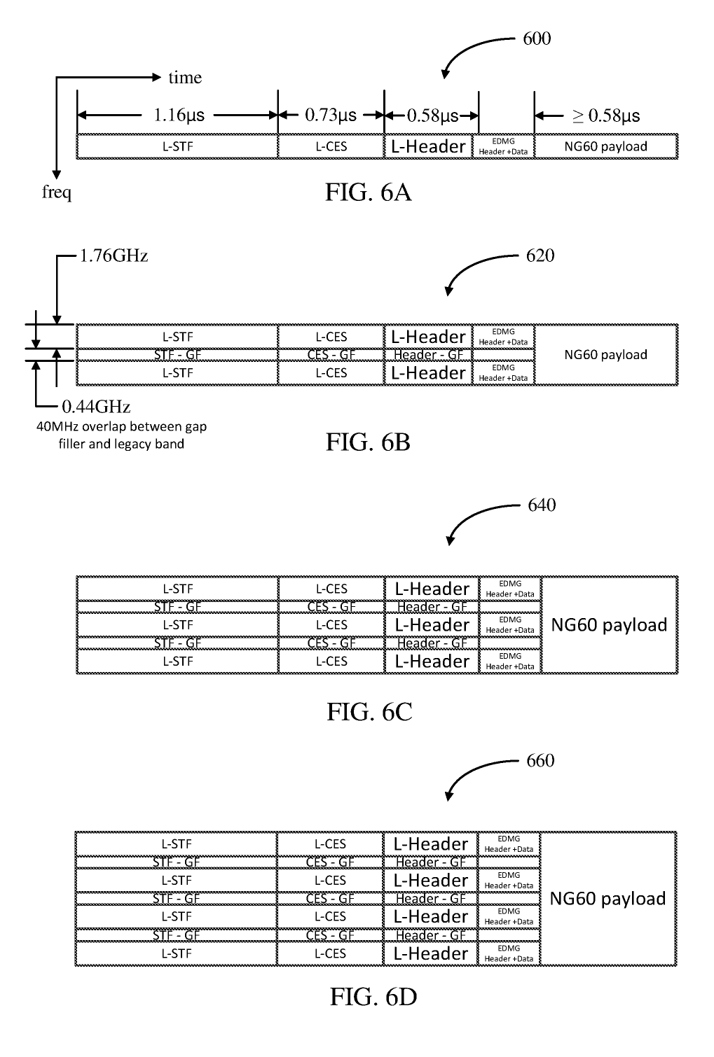

FIGS. 6A-6D illustrate exemplary frames 600, 620, 640, and 660 for transmission via an orthogonal frequency division multiplexing (OFDM) transmission mode in accordance with an aspect of the disclosure. The OFDM frame format is configured to maintain the legacy 802.11ad preamble (L-STF and L-CES) and L-Header as prefix in order to be backwards compliant. In addition, OFDM frames may be transmitted with some backoff to reduce peak to average power ratio (PARP), which needs to be applied to the legacy preambles themselves. In all of the frame diagrams, the vertical or y-axis represents frequency and the horizontal or x-axis represents time.

More specifically, with reference to FIG. 6A, frame 600 is an example of a single-channel OFDM frame including an L-STF, an L-CES, an L-Header, an EDMG Header with optional attached data, and an NG60 (802.11 ay) data payload. The bandwidth of the single-channel may be substantially 1.76 GHz. As previously discussed, the duration or length of the L-STF, L-CES, L-Header, and EDMG Header with optional attached data may be substantially 1.16 μs, 0.73 μs, 0.58 μs, and ≧0.58 μs, such as an integer K multiple of 0.58 μs. As illustrated, the L-STF, L-CES, L-Header, EDMG Header, and NG60 data payload may be transmitted in such order without time gaps between each of the frame portions. The EDMG header of the frame 600 may be encoded and decoded in accordance with the respective operations of apparatuses 400 and 500, previously discussed.

With reference to FIG. 6B, frame 620 is an example of a two bonded channel OFDM frame in accordance with the proposed new protocol (802.11ay). The frame 620 comprises a first (lower frequency) channel (upper channel as shown) for transmitting the legacy preamble (L-STF and L-CES), the L-Header, and the EDMG Header with the optional attached data. The first channel may have a bandwidth of substantially 1.76 GHz. The frame 620 further comprises a second (upper frequency) channel (lower channel as shown) for transmitting the legacy preamble (L-STF and L-CES), L-Header, and the EDMG Header. The transmission of the L-STF, L-CES, and L-Header in the first and second channels is for 802.11ad backward compatibility. The data attached to the EDMG Header for the first channel may be different than the data attached to the EDMG Header of the second channel. The second channel also has a bandwidth of substantially 1.76 GHz. The first channel includes a frequency band that is spaced apart in frequency from the frequency band of the second channel.

Additionally, the frame 620 comprises a gap filling (GF) channel having a frequency band situated in frequency between the first and second frequency bands of the first and second channels. The GF channel may have a bandwidth of substantially 440 MHz (0.44 GHz). Since the total bandwidth for the transmission is 3.92 GHz, the high frequency portion of the first channel may overlap with the low frequency portion of the GF channel by 20 MHz. Similarly, the high frequency portion of the GF channel may overlap with the low frequency portion of the second channel by 20 MHz. However, as discussed in more detail below, a channel estimation sequence portion of the GF channel may be narrowed by filtering to substantially minimize the overlap between the first channel and the GF channel, and between the second channel and the GF channel.

The GF channel comprises a short training field (STF-GF), a channel estimation sequence (CES-GF), and an optional header (Header-GF). The L-STF of the first channel, the STF-GF of the GF channel, and the L-STF of the second channel are transmitted in a substantially time aligned manner That is, the first channel L-STF, the STF-GF, and the second channel L-STF may have substantially the same length or duration, and they are transmitted at substantially the same time. In other words, the transmission of the beginning and end of the first channel L-STF, the STF-GF, and the second channel L-STF are substantially time aligned. The STF-GF may be also based on Golay sequences, and may be also configured substantially the same or similar to the Golay sequences of the first and second channel L-STF. The L-STF of the first and second channels and the STF-GF of the GF channel may be used collectively by a receiver for AGC (power) adjustment and/or other purposes.

Similarly, the L-CES of the first channel, the CES-GF of the GF channel, and the L-CES of the second channel are transmitted in a substantially time aligned manner That is, the first channel L-CES, the CES-GF, and the second channel L-CES may have substantially the same length or duration, and they are transmitted at substantially the same time. In other words, the transmission of the beginning and end of the first channel L-CES, the CES-GF, and the second channel L-CES are substantially time aligned.

The CES-GF may be also based on Golay sequences. The sequences may also be modulated using BPSK modulation, as it is done in the L-CES in accordance with 802.11ad. There may be three (3) options for implementing the CES-GF based on Golay sequences. A first option is for the CES-GF to be based on Golay sequences, each having a length of 32 symbols. For example, the sequences may be the same as the sequences defined in the 802.11ad standard, Table 21-28, reproduced below:

TABLE 21-28
The sequence Ga32(n)
The Sequence Ga32(n), to be transmitted from left to right
+1 +1 +1 +1 +1 −1 +1 −1 −1 −1 +1 +1 +1 −1 −1 +1 +1 +1 −1 −1 +1 −1 −1 +1 −1 −1 −1 −1 +1 −1 +1 −1

A second option is for the CES-GF to be based on Golay sequences, each having a length of 20 symbols. There are various options for building Golay sequences of length 20. For instance, Golay sequences of length 20 may be built from the following seeds of length 10:

Seed “a”: [+1 +1 −1 +1 −1 +1 −1 −1 +1 +1] and Seed “b”: [+1 +1 −1 +1 +1 +1 +1 +1 −1 −1]; or
Seed “a”: [+1 +1 +1 +1 +1 −1 +1 −1 −1 +1] and Seed “b”: [+1 +1 −1 −1 +1 +1 +1 −1 +1 −1]
The seeds may be turned into Golay sequence of length 20 using an [a, b] or [a, −b] construction. Alternatively, the Golay sequences may be based on a Golay sequence of length 20 as follows:

### Golay 20: [+1 +1 +1 +1 −1 +1 −1 −1 −1 +1 +1 −1 −1 +1 +1 −1 +1 −1 −1 +1]; or

### Golay 20: [+1 +1 +1 +1 −1 +1 +1 +1 +1 +1 −1 −1 −1 +1 −1 +1 −1 +1 +1 −1]

A third option is for the CES-GF to be based on Golay sequences, each having a length of 26 symbols. For example, the following may be an example of a Golay sequence of length 26:

### Golay 26: [+1 +1 +1 +1 −1 +1 +1 −1 −1 +1 −1 +1 −1 +1 −1 −1 +1 −1 +1 +1 +1 −1 −1 +1 +1 +1]; or

### Golay 26: [+1 +1 +1 +1 −1 +1 +1 −1 −1 +1 −1 +1 +1 +1 +1 +1 −1 +1 −1 −1 −1 +1 +1 −1 −1 −1]

A receiver may use the L-CES, CES-GF, and L-CES collectively to determine a channel estimation for the frequency ranges associated with the first and second channels and the GF channel Or, in other words, since the NG60 payload is transmitted via a bonded channel having a frequency range that overlaps with or has the substantially the same frequency range as the combined frequency ranges of the first channel, GF channel, and second channel, a receiver may use the L-CES, CES-GF, and L-CES collectively to determine a channel estimation for decoding the data in the NG60 payload.

The remainder of the frame 620 includes the L-Headers transmitted via the first and second channels following the L-CES sequences of the first and second channels, respectively. The GF channel may also include a Header-GF transmitted via the GF channel following the CES-GF. The Header-GF may be optionally transmitted in order to provide additional information beyond the information provided in the L-Header. The L-Headers for the first and second channels, and the Header-GF have substantially the same lengths and are transmitted in a substantially time aligned manner (e.g., the transmission of the beginning and ending of the headers occur at substantially the same time).

Additionally, the frame 620 includes the EDMG Header and optional attached data transmitted via the first and second channels following the corresponding L-Headers. The EDMG Headers for the first and second channels have the substantially same lengths and are transmitted in a substantially time aligned manner (e.g., the transmission of the beginning and ending of the EDMG Headers occur at substantially the same time). Each of the EDMG headers of the frame 620 may be encoded and decoded in accordance with the respective operations of apparatuses 400 and 500, previously discussed.

As illustrated, the frame 620 includes the NG60 (802.11 ay) data payload transmitted via a bonded channel following the EDMG Headers of the first and second channels. Frame 620 is an example of a channel bonding of two as the frequency band of the bonded channel overlaps with the frequency bands of the first and second channels of the frame 620. Or, alternatively, the lower and upper ends of the frequency band of the bonded channel substantially align in frequency with the lower end of the frequency band of the first channel and the upper end of the frequency band of the second channel, respectively. Since the frequency band of the bonded channel also encompasses the frequency band of the GF channel, the L-CES of the first and second channels and the CES-GF of the GF channel are collected by a receiver to determine or generate a channel estimation for the frequency range of the bonded channel to facilitate the receiver decoding the data payload transmitted via the bonded channel.

As previously discussed, the transmission of the L-Header and EDMG Header are transmitted using MCS specified in the legacy 802.11ad protocol. The data in the separate new protocol (802.11 ay) payload is transmitted using one of the MCS specified in the new protocol 802.11 ay. Since the new protocol includes additional MCS beyond those specified in the legacy 802.11ad, the 802.11ay data payload may be transmitted using an MCS different than the MCS used to transmit the L-Header and EDMG Header. However, it shall be understood that the MCS used for transmitting the 802.11ay data payload may be the same as the MCS used for transmitting the L-Header and EDMG Header, as the 802.11ay may include the same MCS specified in the legacy 802.11ad.

Frame 640 is an example of an OFDM frame with a channel bonding of three. Frame 640 is similar to the OFDM type of frame 620 with a channel bonding of two, but includes an additional third channel and an additional second GF channel situated in frequency between the second and third channels. The NG60 data payload is transmitted by way of a bonded channel having a frequency band that overlaps with the frequency bands of the first channel, first GF channel, second channel, second GF channel, and third channel. Or, alternatively, the lower and upper ends of the frequency band of the bonded channel substantially align in frequency with the lower end of the frequency band of the first channel and the upper end of the frequency band of the third channel, respectively. A receiver may collect the L-CES of the first, second, and third channels, and the CES-GF of the first and second GF channels to determine or generate a channel estimation for the frequency range of the bonded channel to facilitate the decoding of the data payload transmitted via the bonded channel. Each of the EDMG headers of the frame 640 may be encoded and decoded in accordance with the respective operations of apparatuses 400 and 500, previously discussed.

Frame 660 is an example of an OFDM type of frame with a channel bonding of four. Frame 660 is similar to OFDM type of frame 640 with a channel bonding of three, but includes an additional fourth channel and an additional third GF channel situated in frequency between the third and fourth channels. The NG60 data payload is transmitted by way of a bonded channel having a frequency band that overlaps with the frequency bands of the first channel, first GF channel, second channel, second GF channel, third channel, third GF channel, and fourth channel. Or, alternatively, the lower and upper ends of the frequency band of the bonded channel substantially align in frequency with the lower end of the frequency band of the first channel and the upper end of the frequency band of the fourth channel, respectively. Similarly, a receiver may collect the L-CES of the first, second, third, and fourth channels, and the CES-GF of the first, second, and third GF channels to determine or generate a channel estimation for the frequency range of the bonded channel to facilitate the decoding of the data payload transmitted via the bonded channel. Each of the EDMG headers of the frame 660 may be encoded and decoded in accordance with the respective operations of apparatuses 400 and 500, previously discussed.

The EDMG Header for the frames 600, 620, 640, and 660 is format-wise essentially the same as the EDMG Header 350 previously discussed, except that the Power difference field bits are indicated as reserved bits. This is because frames 600, 620, 640, and 660 may be transmitted with a substantially uniform average power throughout the duration of the frame.

Although frames 620, 640, and 660 are examples of frames with channel bonding of two, three, and four, respectively, it shall be understood that a frame may be configured in a similar manner to provide more an OFDM frame with channel bonding of more than four.

### Frame Format for OFDM with L-Header and CES-GF Transmitted at the Same Time

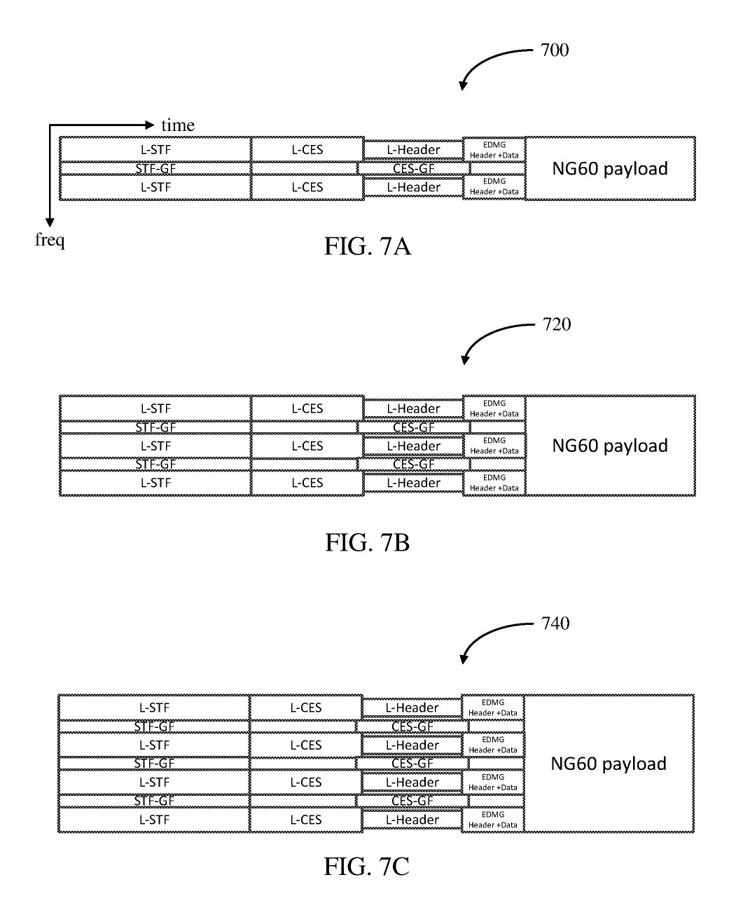

FIGS. 7A-7C illustrate exemplary frames 700, 720, and 740 for transmission of data payload via two, three, and four bonded channels by way of an OFDM transmission in accordance with another aspect of the disclosure. In summary, the CES-GF of one or more gap filling (GF) channels are transmitted at the same as the L-Headers of two or more channels in each of the frames 700, 720, and 740.

Considering the OFDM frame 700 with a channel bonding of two, the frame includes a first (lower frequency) channel for transmission of an L-STF, L-CES, L-Header, and EDMG Header with optional attached data. The frame 700 further comprises a second (upper frequency) channel for transmission of another L-STF, L-CES, L-Header, and EDMG Header with optional attached data. The L-STF, L-CES, L-Header, and EDMG Header of the first and second channels have substantially the same transmission lengths and are transmitted in a substantially time aligned manner. The first channel is associated with a first frequency band and the second channel is associated with a second frequency band different or spaced apart from the first frequency band. The first and second frequency bands each have a bandwidth of substantially 1.76 GHz. Each of the EDMG headers of the frame 700 may be encoded and decoded in accordance with the respective operations of apparatuses 400 and 500, previously discussed.

The frame 700 further comprises a gap filling (GF) channel including a frequency band situated between the respective frequency bands of the first and second channels. The bandwidth of the GF channel may be 440 MHz, wherein 20 MHz of a lower end of the GF channel may overlap (during some portion of the frame) with 20 of the upper end of the first channel, and 20 MHz of the upper end of the GF channel may overlap (during some portion of the frame) with 20 MHz of a lower end of the second channel. The frame 700 includes, for transmission via the GF channel, an STF-GF having substantially the same transmission length or duration as the L-STF of the first and second channels, and configured for transmission in a substantially time aligned manner as the L-STF of the first and second channels. A receiver may receive the L-STF of the first and second channels and the STF-GF of the GF channel to perform AGC (power) adjustment and/or other purposes for receiving the rest of the frame.

The frame 700 further comprises a CES-GF for transmission via the GF channel. The CES-GF may be based on a Golay sequence. For example, the CES-GF may be based on Golay sequences, each having a length of 32 symbols as specified in 802.11ad, Table 21-18, previously discussed with reference to frames 620, 640, and 660. The frame 700 is configured such that a portion of the CES-GF is transmitted at the same time as a portion of the L-Headers of the first and second channels. More specifically, or alternatively, since the CES-GF has a length of substantially 0.73 μs, and the L-Headers each have a length of substantially 0.58 μs, the frame 700 may be configured such that the transmission of the CES-GF begins slightly before the transmission of the L-Headers begins, and ends after the transmission of the L-Headers has ended.

To ease the filter requirement for the CES-GF transmission, the L-Header transmissions may be narrowed in the frequency domain by passing the signal via a narrowing filter (or any similar method) in order to set small frequency gaps between the L-Headers and the CES-GF, respectively.

The frame 700 further comprises an NG60 (802.11 ay) data payload for transmission via a bonded channel. The transmission of the data payload follows the transmission of the EDMG Headers of the first and second channel. The bonded channel has a frequency band that overlaps with the frequency bands of the first and second channels, and the GF channel. More specifically, or alternatively, a lower end of the frequency band of the bonded channel substantially coincides in frequency with a lower end of the frequency band of the first channel, and an upper end of the frequency band of the bonded channel substantially coincides in frequency with an upper end of the frequency band of the second channel.

Since the frequency band of the bonded channel overlaps or substantially coincides with the combined frequency ranges of the first channel, GF channel, and second channel, a receiver may collect the L-CES of the first and second channel, and the CES-GF of the GF channel to determine or generate a channel estimation for the frequency band of the bonded channel Because the L-CES of the first and second channels are transmitted earlier than the CES-GF, the receiver may need to buffer information associated with the L-CES in the process of receiving the CES-GF. The receiver uses the generated channel estimation associated with the bonded channel in order to decode the data payload transmitted via the bonded channel.

Frame 720 is an example of an OFDM frame with a channel bonding of three. Frame 720 is similar to that of OFDM frame 700 with a channel bonding of two, but includes an additional third channel and an additional second GF channel situated in frequency between the second and third channels. The NG60 data payload is transmitted by way of a bonded channel having a frequency band that overlaps with the frequency bands of the first channel, first GF channel, second channel, second GF channel, and third channel. Or, alternatively, the lower and upper ends of the frequency band of the bonded channel substantially align in frequency with the lower end of the frequency band of the first channel and the upper end of the frequency band of the third channel, respectively. A receiver may collect the L-CES of the first, second, and third channels, and the CES-GF of the first and second GF channels to determine or generate a channel estimation for the frequency band of the bonded channel to facilitate the decoding of the data payload transmitted via the bonded channel. Each of the EDMG headers of the frame 720 may be encoded and decoded in accordance with the respective operations of apparatuses 400 and 500, previously discussed.

Frame 740 is an example of an OFDM frame with a channel bonding of four. Frame 740 is similar to that of OFDM frame 720 with a channel bonding of three, but includes an additional fourth channel and an additional third GF channel situated in frequency between the third and fourth channels. The NG60 data payload is transmitted by way of a bonded channel having a frequency band that overlaps with the frequency bands of the first channel, first GF channel, second channel, second GF channel, third channel, third GF channel, and fourth channel. Or, alternatively, the lower and upper ends of the frequency band of the bonded channel substantially align in frequency with the lower end of the frequency band of the first channel and the upper end of the frequency band of the fourth channel, respectively. Similarly, a receiver may collect the L-CES of the first, second, third, and fourth channels, and the CES-GF of the first, second, and third GF channels to determine or generate a channel estimation for the frequency band of the bonded channel to facilitate the decoding of the data payload transmitted via the bonded channel. Each of the EDMG headers of the frame 740 may be encoded and decoded in accordance with the respective operations of apparatuses 400 and 500, previously discussed.

### Frame Format for OFDM with CES-GF Transmitted Simultaneous with Portions of the Data Payload

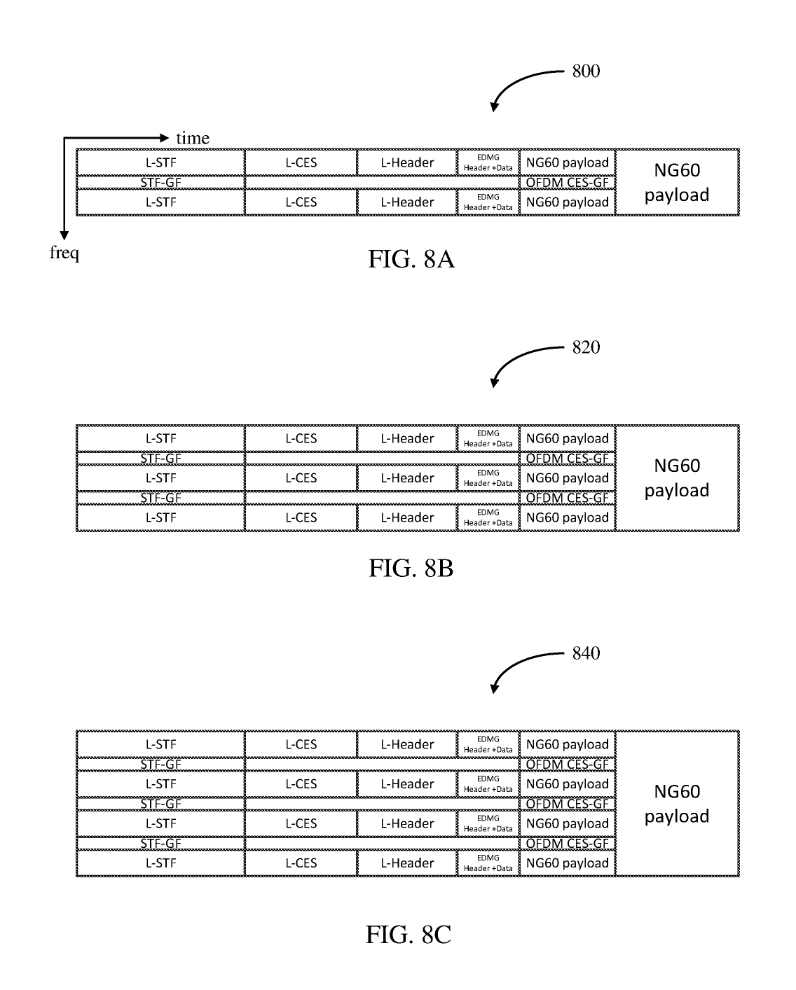

FIGS. 8A-8C illustrate exemplary frames 800, 820, and 840 for transmission of data payload via two, three, and four bonded channels by way of an OFDM transmission in accordance with another aspect of the disclosure. In summary, the CES-GF of one or more gap filling (GF) channels are transmitted at the same time as portions of the NG60 (802.11ay) data payload in each of the frames 800, 820, and 840.

Considering the OFDM frame 800 with a channel bonding of two, the frame includes a first (lower frequency) channel for transmission of an L-STF, L-CES, L-Header, EDMG Header with optional attached data, and a portion (e.g., two OFDM symbols) of the NG60 (802.11ay) data payload. The frame 800 further comprises a second channel (upper frequency) for transmission of another L-STF, L-CES, L-Header, EDMG Header with optional attached data, and another portion (e.g., two OFDM symbols) of the NG60 (802.11 ay) data payload. The L-STF, L-CES, L-Header, EDMG Header, and NG60 data payload portions of the first and second channels have substantially the same transmission lengths and are transmitted in a substantially time aligned manner. The first channel is associated with a first frequency band and the second channel is associated with a second frequency band different or spaced apart from the first frequency band. The first and second frequency bands each have a bandwidth of substantially 1.76 GHz. Each of the EDMG headers of the frame 800 may be encoded and decoded in accordance with the respective operations of apparatuses 400 and 500, previously discussed.

The frame 800 further comprises a gap filling (GF) channel including a frequency band situated between the respective frequency bands of the first and second channels. The bandwidth of the GF channel is 440 MHz, wherein 20 MHz of a lower end of the GF channel may overlap with 20 MHz of the upper end of the first channel, and 20 MHz of the upper end of the GF channel may overlap with 20 MHz of a lower end of the second channel. The frame 800 includes, for transmission via the GF channel, an STF-GF having substantially the same transmission length or duration as the L-STF of the first and second channels, and configured for transmission in a substantially time aligned manner as the L-STF of the first and second channels. A receiver may receive the L-STF of the first and second channels and the STF-GF of the GF channel to perform AGC (power) adjustment for receiving the rest of the frame.

The frame 800 further comprises an OFDM CES-GF for transmission via the GF channel. The OFDM CES-GF may comprise a pilot (information known to a receiver) transmitted during the portions of the NG60 data payloads transmitted via the first and second channels. For instance, the OFDM CES-GF may be transmitted simultaneously or in a time aligned manner with two OFDM data symbols of the portions of the NG60 portions of the NG60 data payload transmitted via the first and second channels. The pilot information may be randomized by a given pseudorandom number generator (PRNG) to avoid spectral/time patterns. The frequency width of the GF channel during the transmission of the CES-GF should be 400 MHz or slightly higher to compensate also for the L-CES edges so that a more accurate channel estimation may be achieved of the frequency band of the bonded channel During the transmission of the portions (e.g., first two OFDM symbols) of the NG60 data payload via the first and second channels, data is placed in subcarriers avoiding pilot carriers, and pilots are placed in the designated pilot subcarriers.

The frame 800 further comprises an NG60 (802.11 ay) data payload for transmission via a bonded channel. The transmission of the data payload via the bonded channel follows the transmission of the portions of the NG60 data payload transmitted via the first and second channels, and the OFDM CES-GF transmitted via the GF channel. The bonded channel has a frequency band that overlaps with the frequency bands of the first and second channels, and the GF channel. More specifically, or alternatively, a lower end of the frequency band of the bonded channel substantially coincides in frequency with a lower end of the first channel, and an upper end of the frequency band of the bonded channel substantially coincides in frequency with an upper end of the second channel.

Since the frequency band of the bonded channel overlaps or substantially coincides with the combined frequency bands of the first channel, GF channel, and second channel, a receiver may collect the L-CES of the first and second channel, and the OFDM CES-GF of the GF channel to determine or generate a channel estimation for the frequency band of the bonded channel. Because the L-CES of the first and second channels are transmitted earlier than the OFDM CES-GF, the receiver may need to buffer information associated with the L-CES while in process of receiving the OFDM CES-GF. The receiver uses the generated channel estimation associated with the bonded channel in order to decode the data payload transmitted via the bonded channel.

Frame 820 is an example of an OFDM frame with a channel bonding of three. Frame 820 is similar to that of OFDM frame 800 with a channel bonding of two, but includes an additional third channel and an additional second GF channel situated in frequency between the second and third channels. The NG60 data payload is transmitted by way of a bonded channel having a frequency band that overlaps with the frequency bands of the first channel, first GF channel, second channel, second GF channel, and third channel. Or, alternatively, the lower and upper ends of the frequency band of the bonded channel substantially aligns in frequency with the lower end of the frequency band of the first channel and the upper end of the frequency band of the third channel, respectively. A receiver may collect the L-CES of the first, second, and third channels, and the OFDM CES-GF of the first and second GF channels to determine or generate a channel estimation associated with the bonded channel to facilitate the decoding of the data payload transmitted via the bonded channel. Each of the EDMG headers of the frame 820 may be encoded and decoded in accordance with the respective operations of apparatuses 400 and 500, previously discussed.

Frame 840 is an example of an OFDM frame with a channel bonding of four. Frame 840 is similar to that of OFDM frame 820 with a channel bonding of three, but includes an additional fourth channel and an additional third GF channel situated in frequency between the third and fourth channels. The NG60 data payload is transmitted by way of a bonded channel having a frequency band that overlaps with the frequency bands of the first channel, first GF channel, second channel, second GF channel, third channel, third GF channel, and fourth channel. Or, alternatively, the lower and upper ends of the frequency band of the bonded channel substantially align in frequency with the lower end of the frequency band of the first channel and the upper end of the frequency band of the fourth channel, respectively. Similarly, a receiver may collect the L-CES of the first, second, third, and fourth channels, and the OFDM CES-GF of the first, second, and third GF channels to determine or generate a channel estimation associated with the bonded channel to facilitate the decoding of the data payload transmitted via the bonded channel. Each of the EDMG headers of the frame 840 may be encoded and decoded in accordance with the respective operations of apparatuses 400 and 500, previously discussed.

### Frame Format for SC WB with L-CES and CES-GF Transmitted Simultaneously

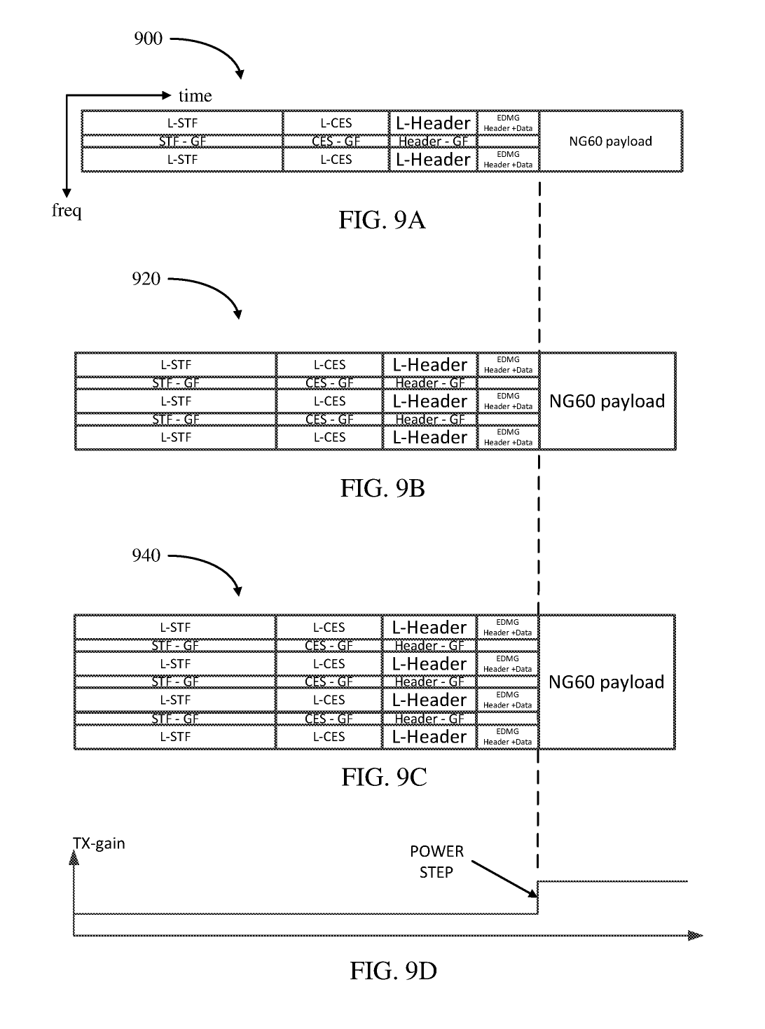

FIGS. 9A-9C illustrate exemplary frames 900, 920, and 940 for transmission of data via single carrier wideband (SC WB) transmission in accordance with an aspect of the disclosure. The frames 900, 920, and 740 may be example frames for transmitting the data payload via channel bonding of two, channel bonding of three, and channel bonding of four, respectively. The structures of the SC WB frames 900, 920, and 940 are substantially the same as the structures of the OFDM frames 620, 640, and 660, respectively. This has the advantage of simplifying the processing of both the SC WB and OFDM frames.

The main difference between the SC WB frames 900, 920, and 940 and the OFDM frames 620, 640, and 660 is that the data payload is transmitted via a SC WB transmission in frames 900, 920, and 940, and the data payload is transmitted via an OFDM transmission in frames 620, 640, and 660. Other differences entail the L-STF, L-CES, L-Header, and EDMG Header/data of the two or more channels, and the one or more GF channels being transmitted at a lower power than the NG60 data payload as indicated in the transmission power profile diagram of FIG. 9D. As previously discussed, the EDMG Header and the L-Header may include bits to signify the transmission power difference between the legacy portion and the NG60 portion of the frames. Also, the L-CES of the SC WB frames 900, 920, and 940 may be based on a different Golay sequence than that of the L-CES of the OFDM frames 620, 640, and 660, as indicated by the 802.11ad protocol. Each of the EDMG headers of each of the frames 900, 920, and 940 may be encoded and decoded in accordance with the respective operations of apparatuses 400 and 500, previously discussed.

### Frame Format for SC WB with L-Header and CES-GF Transmitted at the Same Time

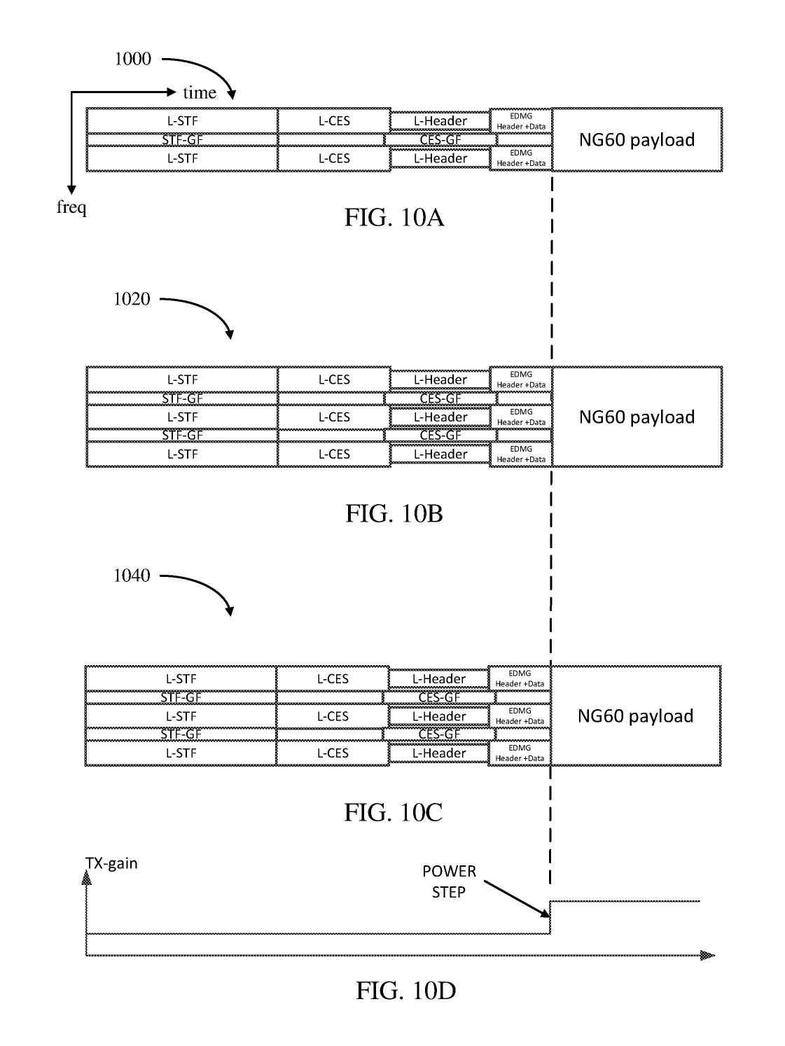

FIGS. 10A-10D illustrates exemplary frames 1000, 1020, and 1040 for transmission of data via single carrier wideband (SC WB) transmission in accordance with an aspect of the disclosure. The frames 1000, 1020, and 1040 may be example frames for transmitting the data payload via a channel bonding of two, channel bonding of three, and channel bonding of four, respectively. The structures of the SC WB frames 1000, 1020, and 1040 are substantially the same as the structures of the OFDM frames 700, 720, and 740, respectively. Again, this is done to simplify the processing of both the SC WB and OFDM frames.

Similarly, the main difference between the SC WB frames 1000, 1020, and 1040 and the OFDM frames 700, 720, and 740 is that the data payload is transmitted via a SC WB transmission in frames 1000, 1020, and 1040, and the data payload is transmitted via an OFDM transmission in frames 700, 720, and 740. Other differences entail the L-STF, L-CES, L-Header, and EDMG Header/data of the two or more channels, and the one or more GF channels being transmitted at a lower power than the NG60 data payload as indicated in the transmission power profile diagram of FIG. 10D. As previously discussed, the EDMG Header and the L-Header may include bits to signify the transmission power difference between the legacy portion and the NG60 portion of the frames. Also, the L-CES of the SC WB frames 1000, 1020, and 1040 may be based on a different Golay sequence than that of the L-CES of the OFDM frames 720, 740, and 760, as indicated by the 802.11ad protocol. Each of the EDMG headers of each of the frames 1000, 1020, and 1040 may be encoded and decoded in accordance with the respective operations of apparatuses 400 and 500, previously discussed.

### Frame Format for SC WB with NG60 CES

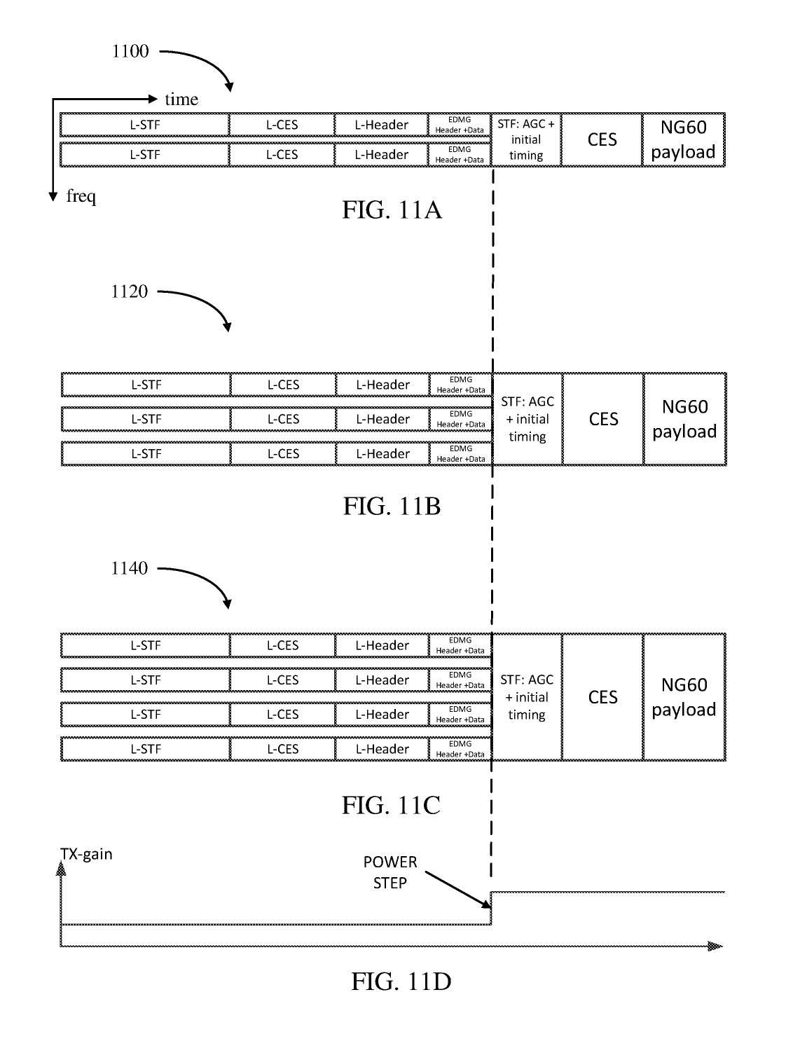

FIGS. 11A-11D illustrate exemplary frames 1100, 1120, and 1140 for transmission of data via single carrier wideband (SC WB) transmission in accordance with an aspect of the disclosure. The frames 1100, 1120, and 1140 may be example frames for transmitting the data payload via a channel bonding of two, channel bonding of three, and channel bonding of four, respectively. Unlike the frames 900, 920, and 940, and frames 1000, 1020, and 1040, frames 1100, 1120, and 1140 do not include a gap filling (GF) channel with a CES-GF. Instead, frames 1100, 1120, and 1140 include an STF and CES for transmission via the corresponding bonded channel.

A receiver uses the L-STF legacy portion of the frames for AGC (power) and timing adjustment based on the backed-off or lower transmit power as indicated in FIG. 11D for receiving the legacy portion of the frames. The receiver also uses the L-CES for determining or generating channel estimations for receiving the legacy portion of the frames. The receiver uses the STF of the bonded channel for AGC (power) and timing adjustment based on the increased transmission power level of the 802.11ay portion of the frames as indicated in FIG. 11D. The receiver uses the CES transmitted via the bonded channel for determining and generating a channel estimation associated with the bonded channel.

As illustrated, the NG60 (802.11ay) transmission includes three (3) sections that are present (STF, CES, and 802.11ay Payload) and an optional beam training sequence (TRN) (not shown). The STF is built on Golay codes (as in the legacy STF). During this period, a receiver is expected to complete: AGC, timing and frequency acquisition. The STF uses Ga and Gb in the same order as the 802.11ad. Optionally, the Golay codes can be 128 (as in 802.11ad) or 256 or 512.

The CES sequence may also be based on a Golay construction of the CES sequence of 802.11ad, only replacing the 128 sequences to 256 sequences for two bonded channels, to 512 sequences for three or four bonded channels, and to 1024 for 5-8 bonded channels. The formats of the Golay sequences of length 256, 512 and 1024 are as follows, using the Ga₁₂₈ and Gb₁₂₈ from the 802.11ad standard:

Ga₂₅₆=[Ga₁₂₈ Gb₁₂₈] and Gb₂₅₆=[Ga₁₂₈ −Gb₁₂₈]

Ga₅₁₂=[Ga₂₅₆ Gb₂₅₆] and Gb₅₁₂=[Ga₂₅₆ −Gb₂₅₆]

Ga₁₀₂₄=[Ga₅₁₂ Gb₅₁₂] and Gb₁₀₂₄=[Ga₅₁₂ −Gb₅₁₂]

The data Payload is modulated using MSC similar to the 802.11ad with the following changes: (1) In addition to BPS K, QPSK and 16QAM, higher modulations are defined (and can be used): 64QAM, 64APSK, 128APSK, 256QAM, 256APSK; (2) 1-1-T block can be 512 (as in 802.11ad) or 768, 1024, 1536 or 2048; and (3) GI is also Golay code as in 802.11ad, with more length options supported: 32, 64 (as in 802.11ad), 128 or 256.

As previously discussed, the beam training sequence (TRN) is optional in all cases. Note that if the 802.11ay section is not used, then the TRN is same as in 802.11ad. When 802.11ay section is used, then it uses the 802.11ay TRN options. 802.11ay TRN field is built in the same way as the 802.11ad, with options to increase the Golay codes by factor of 2 or 4 (e.g. use Golay of 256 or 512, instead of 128).

With regard to exemplary frame 1100, this case is the extension of 802.11 ay for a two channel bonding case. The frame 900 comprises a first channel (upper channel shown) for transmitting the legacy preamble (L-STF and L-CES), L-Header, and EDMG Header with optional attached data. The frame 1100 further comprises a second channel (lower channel shown) for transmitting the legacy preamble (L-STF and L-CES), L-Header, and EDMG Header with optional attached data. Note, that the attached data following the EDMG Header of the first channel may be different than the attached data following the EDMG header of the second channel. The information fields of the EDMG Header may be configured as per EDMG Header 350 previously discussed. Each of the EDMG headers of the frame 1100 may be encoded and decoded in accordance with the respective operations of apparatuses 400 and 500, previously discussed.

The 802.11ay section of the frame 1100, namely the STF, CES, 802.11ay Payload, and optional TRN transmitted via a bonded channel has a frequency band that overlaps with the frequency bands of the first and second channels. As previously discussed, the transmission of the L-STF, L-CES, L-Header, and EDMG Header uses an MCS specified in legacy 802.11ad, and the transmission of the 802.11ay STF, CES, and data payload uses an MCS specified in 802.11ay, both of which may be different.

With regard to exemplary frame 1120, this case is the extension of 802.11ay frame for a three (3) channel bonding case. With regard to exemplary frame 1140, this case is the extension of 802.11ay frame for the four (4) channel bonding case. From the above drawings, it is clear that the method is extendable to any number of contiguous channels. Each of the EDMG headers of each of the frames 1120 and 1140 may be encoded and decoded in accordance with the respective operations of apparatuses 400 and 500, previously discussed.

When a station transmits on more than one channel, it may shift the symbol time between channels by any amount of time with the only constrain that the maximum difference between the earliest and latest will not exceed 1 symbol time in 1.76 GHz sampling rate. It means that the maximum difference is limited to 0.568 nsec. The main reason for doing so is to reduce the aggregated PAPR. The time synchronization between the aggregate portion and the 802.11ay portion should be kept relative to the first (lowest-frequency) channel. Note that this skew is only for SC transmissions and not allowed in OFDM modes. Example: in two channels mode the shift can be ½ symbol, in tree channels it can be ⅓ and ⅔ symbols, and in four channels ¼, ½ and ¾ symbols respectively.

FIG. 11D illustrate an exemplary transmission power profile for any of the exemplary frames 1100, 1120, and 1140 in accordance with another aspect of the disclosure. The use of 802.11ay data and Aggregate legacy preambles and Header impose different transmitter back-offs due to PAPR differences and practical PAs. For any modulation scheme, one transmission has less PAPR than if the same modulation is used for two or more aggregated signals in order to keep the error vector magnitude (EVM) and/or transmission mask in compliance. It should be noted that different modulations have different PAPR, thus requiring different back-offs. The backoff value is implementation dependent (mainly on the PA).

In order to keep the 802.11ay transmission as efficient as possible in many cases, the legacy section transmitted in aggregation mode will require a higher backoff. This difference is an issue that may affect the receiver performance To help receivers mitigate this, it is suggested that two mechanisms one for the legacy receivers and one for the targeted 11 ay receiver may be employed. The transmitted power change is at the switch from aggregated period to the 802.11ay period, as shown in FIG. 11D.

The targeted 802.11ay receiver usually adjust the receive chain at the beginning of the L-STF. If there is a power change between the legacy portion and the 802.11ay portion, the receiver may get into saturation. The receiver can adjust the AGC during the 802.11ay STF, but this may reduce the time allotted for other activities, such as frequency and time acquisition on the 802.11ay signal. To help the receiver, the Power difference field in the EDMG Header specifies the power step. The receiver may use it to anticipate the required AGC step, thus shortening the AGC processing for the 802.11ay portion.

Legacy receivers (802.11ad) that receive the legacy preamble and L-Header, use these portions to update the NAV as one of the collision avoidance methods. However, these receivers also look at the received power, since in some cases, the received power is low enough to allow reuse of the medium. In this case, the power step can mislead some of the receivers if the power is near the border. The update to the L-Header format, as previously mentioned, describes an option to signal the power step. A legacy receiver that can decode these bits may act upon it to improve its power estimation. Note that this functionality is not critical for the collision avoidance system, and legacy receivers can operate without it.

Since the modes are using most of the reserved bits, and there is some need to have some additional bits (e.g., to signal power step in 802.11ay mode), the LSBs of the Data Length field may be used for this purpose. In all 802.11ay modes, the legacy length bits are only used for NAV computation. By using up to 4 bits for all MCSs (and even more if MSC-1 is excluded), the NAV computation is not affected. The 3 LSB bits of the legacy length are used to signal the power difference between the 802.11ad like part (L-STF, L-CES, L-Header and EDMG Header) and the Wideband (WB) 802.11ay part (Additional STF, CES and the 11ay data payload) in accordance with the following table:

| Bits | Power difference X [dB] |
|---|---|
| 001 | X <= 1 |
| 010 | 1 < X <= 2.5 |
| 011 | 2.5 < X <= 4 |
| 100 | 4 < X <= 5.5 |
| 101 | 5.5 < X <= 7 |
| 110 | 7 < X <= 8.5 |
| 111 | 8.5 < X |

### Frame Format for Short Messages

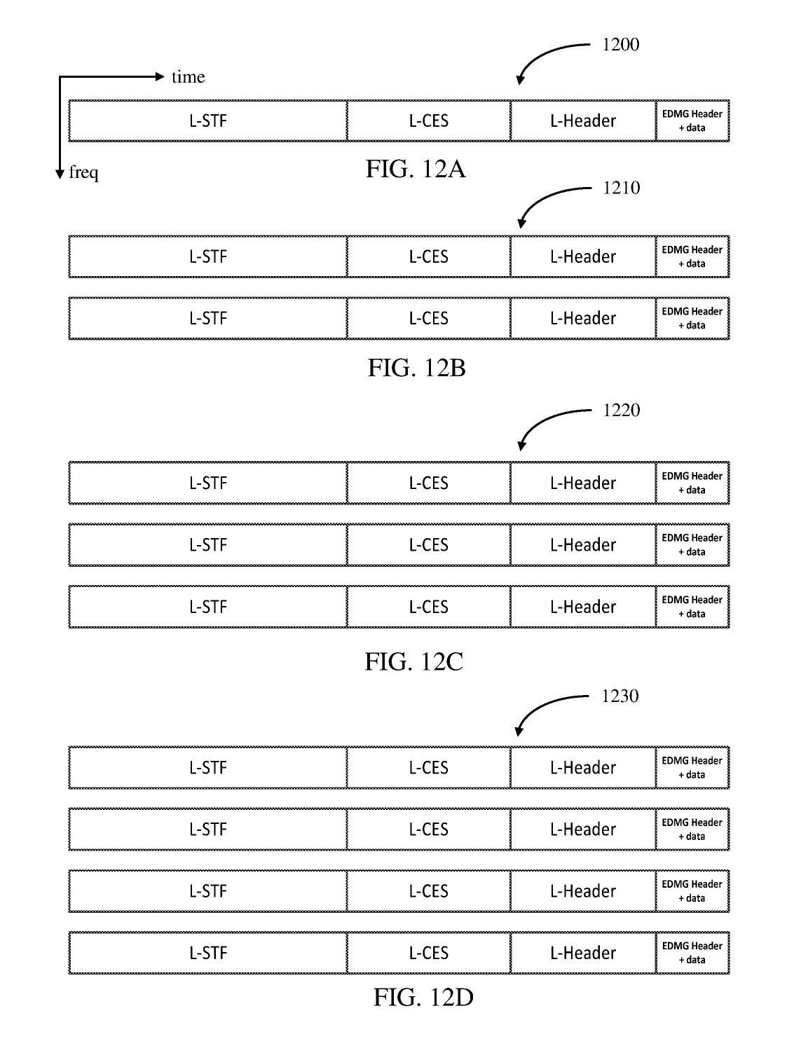

FIGS. 12A-12D illustrate exemplary frames 1200, 1210, 1220, and 1230 for transmission of short messages in accordance with another aspect of the disclosure. Frame 1200 is an example of a single-channel frame. Frame 1210 is an example of a two-channel frame. Frame 1220 is an example of a three-channel frame. And, frame 1230 is an example of a single-channel frame.

Each channel of the frames include the legacy L-STF, L-CES, and L-Header. Additionally, each channel of the frames include an EDMG Header with attached data. There is no NG60 (802.11ay) data payload in the frames 1200, 1210, 1220, and 1230, as all the data is transmitted via the data attached to the EDMG Header. With regard to the multi-channel frames 1210, 1220, and 1230, the attached data in the EDMG headers may be all the same or different. As previously discussed, the attached data is transmitted via a selected one of a plurality of MCS as specified in the 802.11ad protocol. Each of the EDMG headers of each of the frames 1200, 1210, 1220, and 1230 may be encoded and decoded in accordance with the respective operations of apparatuses 400 and 500, previously discussed.

### Frame Format for Aggregate SC

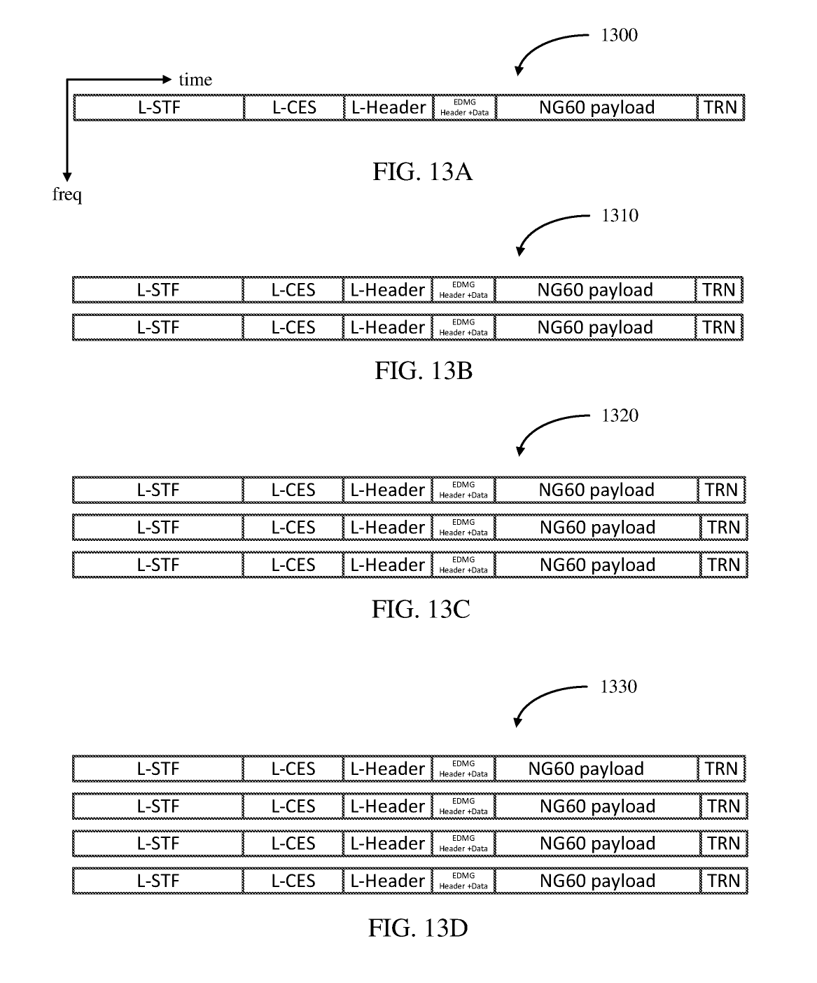

FIGS. 13A-13D illustrate exemplary frames 1300, 1310, 1320, and 1330 for transmission of an aggregate single carrier (SC) signal in accordance with another aspect of the disclosure. Transmission in aggregate mode is an aggregation of legacy 802.11ad channels. Since the 802.11ay extends the modes of the 802.11ad, there is a need for EDMG Header bits.

The frame formats for both aggregate SC and SC WB (as discussed further herein) are similar in that their first sections (L-STF, L-CES, L-Header and EDMG Header), and different than the rest of the transmission. The similar part is kept the same since it is backward compatible with 802.11ad for the backward compatibility feature. It means that legacy (802.11ad) devices will be able to detect it and decode the L-Header. As previously discussed, this feature allows legacy devices to update the NAV, which is part of the collision avoidance method. Furthermore, in channel bonded (CB) mode, the L-STF, L-CES, and L-Header are transmitted on all used channels to facilitate legacy devices on all channels to get the NAV.

The legacy (L-STF+L-CES+L-Header) and the EDMG Header should be transmitted with the same power across aggregated channels. However, due to RF impairments, actual effective isotropic radiated power (EIRP) may differ. The 802.11ay additional header, aka “EDMD Header” is also transmitted in the 802.11ad channels. As previously discussed, the EDMG Header includes information that is part of the 802.11ay transmission only and also 802.11ay Data may be appended to the same symbol. The following considerations apply: (1) The L-STF and L-CES apply (no need for additional CES); (2) Modulation and coding as defined in the L-Header for 802.11ad Data; (3) Data appended to same symbol to improve overhead for short messages; (4) Data is split across channels in CB mode to improve overhead; and (5) the average power should be kept the same (means that the power of STF, CE, Header and Extended Header are same) in each channel.

Frame 1300 case is the extension of 802.11ay for a single channel case. It facilitates the new MCSs of 802.11ay for the 802.11ay data payload and optional TRN. Frame 1310 is the extension of 802.11ay for the two channel case. Frame 1320 is the extension of 802.11ay for a three channel case. And, Frame 1330 is the extension of 802.11ay for four channel case. The EDMG Header and attached Data are same as described for the SC WB mode, except that there are no Power difference bits; they are added to the “Reserved bits”. Each of the EDMG headers of each of the frames 1300, 1310, 1320, and 1330 may be encoded and decoded in accordance with the respective operations of apparatuses 400 and 500, previously discussed.

There are three implementation options for the aggregate SC: (1) Each channel is independent; (2) all channels are mixed; and (3) all channels are transmitted in parallel. In this first option, each channel is independent. The MCS for the 802.1 lay section can be different in each channel. The LDPC blocks are confined to one channel, and each channel has its own blocks. Transmitter may assign different power per channel, but the power shall be fixed for the entire transmission. In this case, the EDMG Header can be different in each channel (e.g., different MCS per channel).

In the second option, all channels are bonded and mixed. The MCS for the 802.11ay section is the same for all channels. The LDPC blocks are spread evenly between the channels. Transmitter may (and should) assign different power per channel to even the detection probability of each channel, but the power shall be fixed during the entire transmission. In this option, the EDMG Header will be same in each channel.

In the third option, the MCS for transmitting data in the 802.11ay (NG60) data payload is the same for all aggregate channels. However, each channel has independent encoded (e.g., LDPC) blocks. Each channel is similar and operate in parallel. The transmitter may (and should) assign different power per channel to even the detection probability of each channel, but the power shall be fixed during the entire transmission. The transmitter fills the LDPC blocks one by one sequentially keeping the channel load event. The last LDPC block in some channels (but not all) can be filled with padding. In this option, the EDMG Header will be same in each channel.

Another transmission mode that is similar to aggregate-SC is duplicate-SC. More specifically, in duplicate-SC, the transmission of the aggregate channels is the same as third transmission option of the aggregate-SC with the special restriction that the same data is transmitted in all channels. In other words, each channel is an exact “copy” of the other channel.

### Frame Format for MIMO

For MIMO, the legacy preambles (L-STF and L-CES), along with the EDMG Header are sent in each transmit chain. Similar to 802.11ac, delay is inserted between all transmissions to prevent unintentional beamforming.

For MIMO channel estimation, various techniques may be used in order to estimate the channel, without causing too much latency, and keeping substantially the same SNR. First is the use of delay between the sequences. If this delay is 36.4 ns, then channel estimations can be separated at the receiver since the channel delay is no larger than 64 samples at 1.76 GHz. Second is the transmission of multiple sequences using P_{HTLTF}, taken form 802.11mc, section 20.3.9.4.6. Third is the transmission of conjugate vs regular sequence. Forth one is the transmission of multiple sequences using P_{VHTLTF} as defined in 22.3.8.3.5 in 802.11mc. Fifth, is to increase the length of the channel estimation for increased MIMO estimation accuracy. Increasing the length is done using the techniques above (forth technique), with the same Golay sequences. This option avoids the use of conjugated or delay sequence since it doubles the integration time of the channel estimation.

### Frame Format for OFDM MIMO

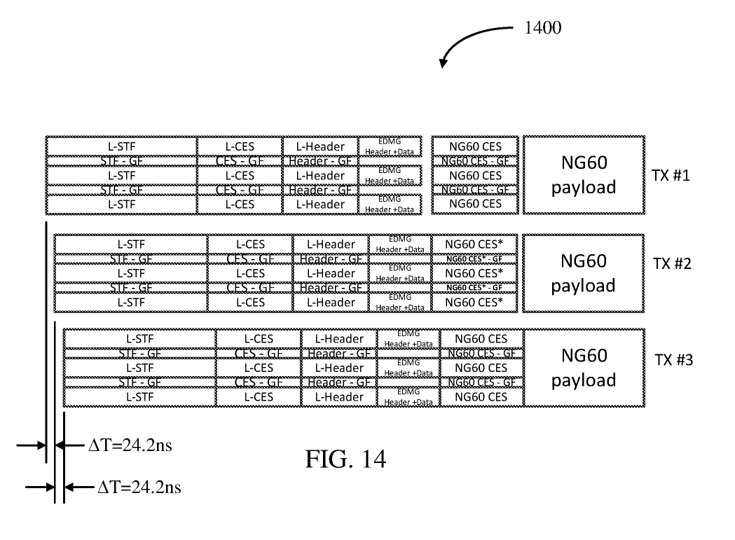

FIG. 14 illustrates exemplary frames 1400 for transmission of three (3) spatial streams in a MIMO OFDM signal using channel bonding of three (3) in accordance with an aspect of the disclosure. The transmitted preambles (L-STF and L-CES) and L-Header are transmitted with a delay between them. For the case of MIMO up to 2×2, this delay is used to estimate the MIMO channel by applying the SISO channel estimation sequence of the channel bonding in OFDM. For more than 2 streams, there is a need to include a new channel estimation sequence, which follows the EDMG Header signaling. This channel estimation sequences follow the same format as those for channel bonding, with the additional dimensions added to the estimation using the approaches above. Frame 1400 is an example for channel boding of 3, and MIMO of 3. As illustrated, the gap-filler sequences can be used also for estimating MIMO channels, by using zero cross-correlation pairs of complex complementary sequences, as illustrated. Each of the EDMG headers of the frame 1400 may be encoded and decoded in accordance with the respective operations of apparatuses 400 and 500, previously discussed.

### Frame Format for WB SC MIMO

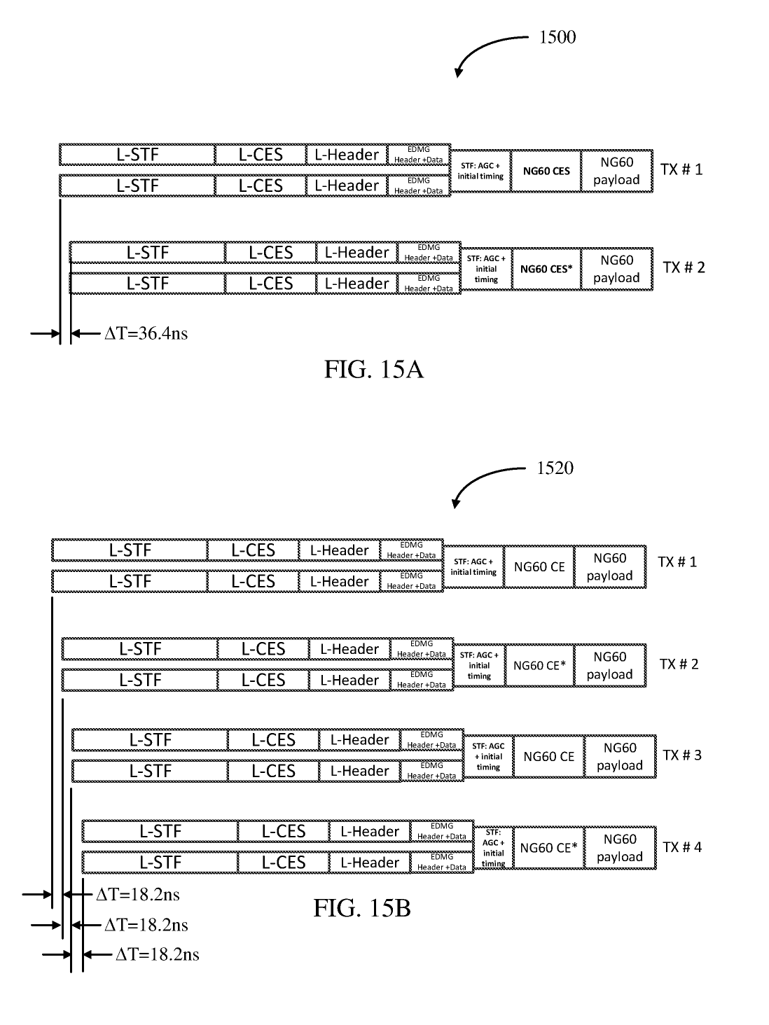

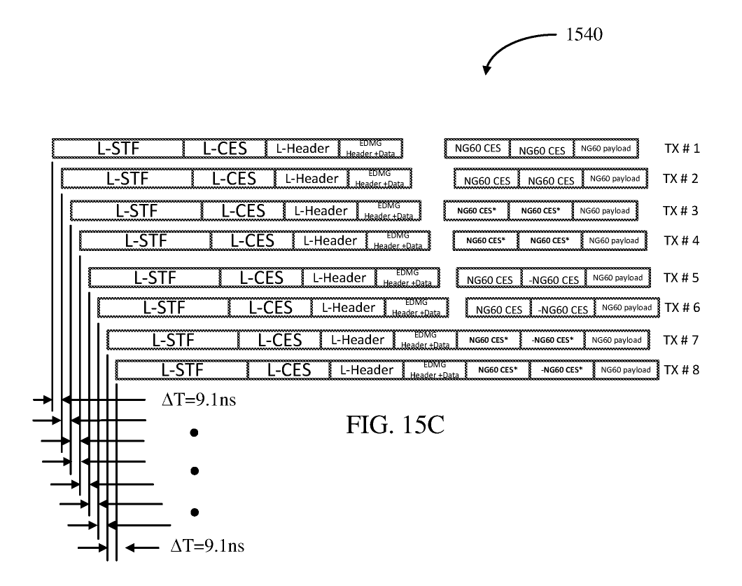

FIGS. 15A-15C illustrate exemplary frames 1500, 1520, and 1540 for transmission of two (2), four (4), and eight (8) spatial streams in a MIMO SC WB signal in accordance with an aspect of the disclosure. For SC WB, the transmission is divided into two stages, before the beginning of the 802.11ay STF and after it. Before the transmission of the 802.11ay STF, the MIMO transmission includes the L-STF, L-CES, L-Header, and the EDMG Header, such that each transmit chain is sending this same signal, just delayed by 64 samples at 1.76 GHz. This is done in order to assure no unintentional beamforming is happening. During the 802.11ay STF field, all transmitting antennas send the same data. Then, in the 802.11 CES time interval, each antenna is sending different sequences, so to allow the receiver to estimate the entire spatial channel.

Exemplary frame 1500 is an example channel estimation for 2 spatial streams, 2 channel bonding. Exemplary frame 1520 is an example channel estimation for 4 spatial streams, 2 channel bonding. Exemplary frame 1540 is an Example channel estimation for 8 spatial streams, single channel Each of the EDMG headers of the frames 1500, 1520, and 1540 may be encoded and decoded in accordance with the respective operations of apparatuses 400 and 500, previously discussed.

### Frame Format for Aggregate SC MIMO

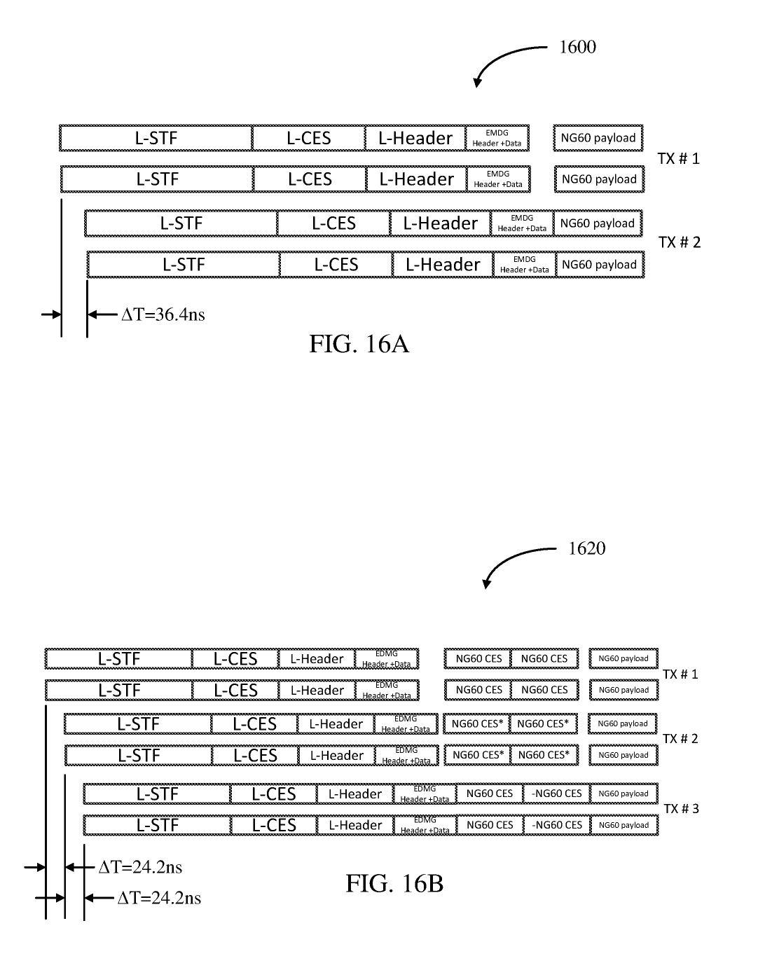

FIGS. 16A-16B illustrate exemplary frames 1600 and 1620 for transmission of two (2) and three (3) spatial streams in a MIMO aggregate SC signal in accordance with another aspect of the disclosure. MIMO aggregate SC uses the same technique as the SC-WB mode, i.e. the three methods, with the difference of the channel estimation in the gap between the band not being transmitted (which is not MIMO related anyway), so the basic sequences are 802.11ad CES sequences transmitted multiple times.

Exemplary frame 1600 is an example is given below for the 2 channel with 2 MIMO. Then there is no need for adding additional CES sequence, because the MIMO channel estimation is done using the L-CES of the legacy preamble. Exemplary frame 1620 is an another example for the case of 3 channel with 3 MIMO, then additional sequences are needed in order to estimate the channel. The proposed sequences are like the one used for the SC WB above. Each of the EDMG headers of the frames 1600 and 1620 may be encoded and decoded in accordance with the respective operations of apparatuses 400 and 500, previously discussed.

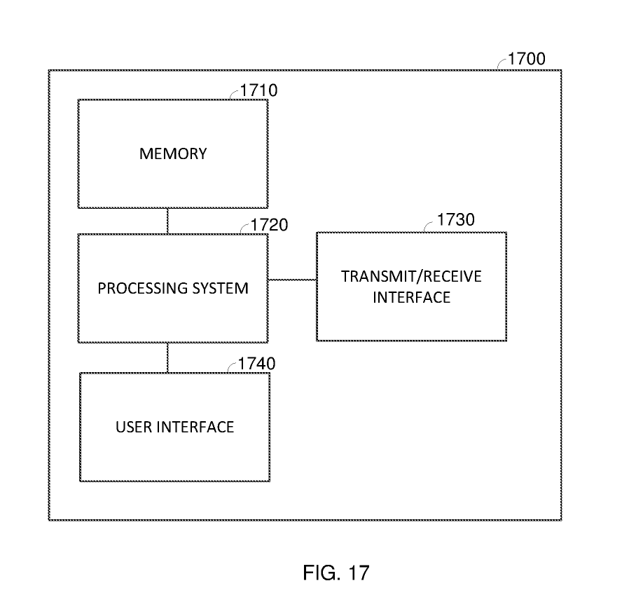

FIG. 17 illustrates an example device 1700 according to certain aspects of the present disclosure. The device 1700 may be configured to operate in an access point (e.g., access point 210) or an access terminal (e.g., access terminal) and to perform one or more of the operations described herein. The device 1700 includes a processing system 1720, and a memory 1710 coupled to the processing system 1720. The memory 1710 may store instructions that, when executed by the processing system 1720, cause the processing system 1720 to perform one or more of the operations described herein. Exemplary implementations of the processing system 1720 are provided below. The device 1700 also comprises a transmit/receiver interface 1730 coupled to the processing system 1720. The interface 1730 (e.g., interface bus) may be configured to interface the processing system 1720 to a radio frequency (RF) front end (e.g., transceivers 226-1 to 226-N, and 266).

In certain aspects, the processing system 1720 may include one or more of the following: a transmit data processor (e.g., transmit data processor 218 or 260), a frame builder (e.g., frame builder 222 or 262), a transmit processor (e.g., transmit processor 224 or 264) and/or a controller (e.g., controller 234 or 274) for performing one or more of the operations described herein. In these aspects, the processing system 1720 may generate a frame and output the frame to an RF front end (e.g., transceiver 226-1 to 226-N or 266) via the interface 1730 for wireless transmission (e.g., to an access point or an access terminal).

In certain aspects, the processing system 1720 may include one or more of the following: a receive processor (e.g., receive processor 242 or 282), a receive data processor (e.g., receive data processor 244 or 284) and/or a controller (e.g., controller 234 or 274) for performing one or more of the operations described herein. In these aspects, the processing system 1720 may receive a frame from an RF front end (e.g., transceiver 226 or 266) via the interface 1730 and process the frame according to any one or more of the aspects discussed above.

In the case of an access terminal 220, the device 1700 may include a user interface 1740 coupled to the processing system 1720. The user interface 1740 may be configured to receive data from a user (e.g., via keypad, mouse, joystick, etc.) and provide the data to the processing system 1720. The user interface 1740 may also be configured to output data from the processing system 1720 to the user (e.g., via a display, speaker, etc.). In this case, the data may undergo additional processing before being output to the user. In the case of an access point 210, the user interface 1740 may be omitted.

The processing system 1720 may perform the operations of the apparatus 400, the apparatus 500, or both the apparatuses 400 and 500. With regard to apparatus 400, the processing system 1720 may perform the operations of one or more of the first appending or concatenating device 410, error correction encoder 412, header repeater 414, parity repeater 416, header encoder 420, parity encoder 422, combiner 424, the second appending or concatenating device 426, and modulator 428, as previously discussed in detail. With regard to apparatus 500, the processing system 1720 may perform the operations of one or more of the demodulator 510, splitter 512, header decoder 514, parity decoder 516, header combiner 518, parity combiner 520, appending or concatenating device 522, and error correction decoder 524.

With regard to the various claimed “means for” element, the transmit data processor 218, transmit data processor 260, error correction encoder 412, and processing system 1720 are some examples of means for generating a plurality of parity bits comprising means for encoding a plurality of data bits. The transmit data processor 218, transmit data processor 260, header repeater 414, and processing system 1720 are some examples of means for generating a first sequence of bits comprising M repetitions of the data bits. The transmit data processor 218, transmit data processor 260, parity repeater 416, and processing system 1720 are some examples of means for generating a second sequence of bits comprising N repetitions of the parity bits.

The transmit data processor 218, transmit data processor 260, combiner 424, and processing system 1720 are some examples of means for generating a third sequence of bits based on the first and second sequences of bits. The transmit data processor 218, transmit data processor 260, modulator 428, and processing system 1720 are some examples of means for generating a sequence of modulation symbols based on the third sequence of bits. The frame builder 222, frame builder 262, and processing system 1720 are some examples of means for generating a frame comprising the sequence of modulation symbols. The transmit processor 224, transmit processor 264, and transmit/receive interface 1730 are some examples of means for outputting the frame for transmission.

The transmit data processor 218, transmit data processor 260, error correction encoder 412, and processing system 1720 are some examples of means for performing low density parity check (LDPC) encoding of the data bits. The transmit data processor 218, transmit data processor 260, appending or concatenating device 410, and processing system 1720 are some examples of means for generating a fourth sequence of bits by at least padding the data bits with a fifth sequence of bits. The transmit data processor 218, transmit data processor 260, error correction encoder 412, and processing system 1720 are some examples of means for encoding the fourth sequence of bits. The transmit data processor 218, transmit data processor 260, error correction encoder 412, and processing system 1720 are some examples of means for performing low density parity check (LDPC) encoding of the fourth sequence of bits.

The transmit data processor 218, transmit data processor 260, header encoder 420, and processing system 1720 are some examples of means for generating a fourth sequence of bits including means for encoding the first sequence of bits. The transmit data processor 218, transmit data processor 260, header encoder 420, and processing system 1720 are some examples of means for performing a one-time pad encryption of the first sequence of bits.

The transmit data processor 218, transmit data processor 260, parity encoder 422, and processing system 1720 are some examples of means for generating a fourth sequence of bits by encoding the second sequence of bits. The transmit data processor 218, transmit data processor 260, parity encoder 422, and processing system 1720 are some examples of means for performing a one-time pad encryption of the second sequence of bits.

The transmit data processor 218, transmit data processor 260, combiner 424, and processing system 1720 are some examples of means for interleaving the first sequence of bits with the second sequence of bits. The transmit data processor 218, transmit data processor 260, header encoder 420, and processing system 1720 are some examples of means for encoding the first sequence of bits to generate a fourth sequence of bits. The transmit data processor 218, transmit data processor 260, parity encoder 422, and processing system 1720 are some examples of means for encoding the second sequence of bits to generate a fifth sequence of bits. The transmit data processor 218, transmit data processor 260, combiner 424, and processing system 1720 are some examples of means for means for interleaving the fourth and fifth sequences of bits.

The transmit data processor 218, transmit data processor 260, appending or concatenating device 426, and processing system 1720 are some examples of means for padding the sixth sequence of bits with a seventh sequence of bits. The transmit data processor 218, transmit data processor 260, modulator 428, and processing system 1720 are some examples of means for performing quadrature phase shift keying (QPSK) modulation of the third sequence of bits.

The receive processor 242, receive processor 282, and processing system 1720 are some examples of means for receiving a frame comprising a sequence of modulation symbols. The receive processor 242, receive processor 282, demodulator 510, and processing system 1720 are some examples of means for generating a first sequence of bits based on the sequence of modulation symbols. The receive processor 242, receive processor 282, header decoder 514, and processing system 1720 are some examples of means for generating M sequences of bits based on the first sequence of bits. The receive processor 242, receive processor 282, parity decoder 516, and processing system 1720 are some examples of means for generating N sequences of bits based on the first sequence of bits.

The receive processor 242, receive processor 282, header combiner 518, and processing system 1720 are some examples of means for generating a second sequence of bits including means for combining the M sequences of bits. The receive processor 242, receive processor 282, parity combiner 520, and processing system 1720 are some examples of means for generating a second sequence of bits including means for generating a third sequence of bits including means for combining the N sequences of bits. The receive processor 242, receive processor 282, error correction decoder 524, and processing system 1720 are some examples of means for generating data bits by at least decoding the second sequence of bits based at least on the third sequence of bits.

The receive processor 242, receive processor 282, demodulator 510, and processing system 1720 are some examples of means for demodulating the sequence of modulation symbols. The receive processor 242, receive processor 282, demodulator 510, and processing system 1720 are some examples of means for performing a quadrature phase shift keying (QPSK) demodulation of the sequence of modulation symbols. The receive processor 242, receive processor 282, splitter 512, and processing system 1720 are some examples of means for generating a fourth sequence of bits and a fifth sequence of bits by de-interleaving the first sequence of bits.

The receive processor 242, receive processor 282, header decoder 514, and processing system 1720 are some examples of means for decoding the fourth sequence of bits. The receive processor 242, receive processor 282, header decoder 514, and processing system 1720 are some examples of means for performing a one-time pad decryption of the fourth sequence of bits. The receive processor 242, receive processor 282, parity decoder 516, and processing system 1720 are some examples of means for decoding the fifth sequence of bits. The receive processor 242, receive processor 282, parity decoder 516, and processing system 1720 are some examples of means for performing a one-time pad decryption of the fifth sequence of bits.

The receive processor 242, receive processor 282, header combiner 518, and processing system 1720 are some examples of means for performing a maximum ratio combining (MRC) of the M sequences of bits. The receive processor 242, receive processor 282, parity combiner 520, and processing system 1720 are some examples of means for performing a maximum ratio combining (MRC) of the N sequences of bits.

The receive processor 242, receive processor 282, appending or concatenating device 522, and processing system 1720 are some examples of means for generating a fourth sequence of bits including means for appending a fifth sequence of bits to the second sequence of bits. The receive processor 242, receive processor 282, error correction decoder 524, and processing system 1720 are some examples of means for decoding the fourth sequence of bits based on the third sequence of bits. The receive processor 242, receive processor 282, error correction decoder 524, and processing system 1720 are some examples of means for performing a low density parity check (LDPC) decoding of the second sequence of bits.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It shall be understood that the processing as described herein may be performed by any digital means as discussed above, and or any analog means or circuitry.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of legacy user device 106, updated legacy user device 108, or new protocol user device 110 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to:
generate a plurality of parity bits by at least encoding a plurality of data bits;
generate a first sequence of bits comprising M repetitions of the data bits;
generate a second sequence of bits comprising N repetitions of the parity bits;
generate a third sequence of bits based on the first and second sequences of bits;
generate a sequence of modulation symbols based on the third sequence of bits; and
generate a frame comprising the sequence of modulation symbols; and
an interface configured to output the frame for transmission.

2. The apparatus of claim 1, wherein the frame comprises a header including the sequence of modulation symbols.

3. The apparatus of claim 1, wherein the at least encoding of the data bits comprises performing low density parity check (LDPC) encoding of the data bits.

4. The apparatus of claim 1, wherein the processing system is further configured to generate a fourth sequence of bits by at least padding the data bits with a fifth sequence of bits, and wherein the generation of the parity bits comprises encoding the fourth sequence of bits.

5. The apparatus of claim 1, wherein the processing system is further configured to generate a fourth sequence of bits by at least padding the data bits with a fifth sequence of bits, and wherein the generation of the parity bits comprises performing low density parity check (LDPC) encoding of the fourth sequence of bits.

6. The apparatus of claim 1, wherein M is different than N.

7. The apparatus of claim 1, wherein the processing system is further configured to generate a fourth sequence of bits by encoding the first sequence of bits, and wherein the generation of the third sequence of bits is based on the fourth sequence of bits.

8. The apparatus of claim 7, wherein the encoding of the first sequence of bits comprises performing a one-time pad encryption of the first sequence of bits.

9. The apparatus of claim 7, wherein the encoding of the first sequence of bits comprises performing a one-time pad scrambling of the first sequence of bits.

10. The apparatus of claim 1, wherein the processing system is further configured to generate a fourth sequence of bits by encoding the second sequence of bits, and wherein the generation of the third sequence of bits is based on the fourth sequence of bits.

11. The apparatus of claim 10, wherein the encoding of the second sequence of bits comprises performing a one-time pad encryption of the second sequence of bits.

12. The apparatus of claim 10, wherein the encoding of the second sequence of bits comprises performing a one-time pad scrambling of the second sequence of bits.

13. The apparatus of claim 1, wherein the generation of the third sequence of bits comprises interleaving the first sequence of bits with the second sequence of bits.

14. The apparatus of claim 1, wherein the generation of the third sequence of bits comprises:
encoding the first sequence of bits to generate a fourth sequence of bits;
encoding the second sequence of bits to generate a fifth sequence of bits; and
interleaving the fourth and fifth sequences of bits.

15. The apparatus of claim 1, wherein the generation of the third sequence of bits comprises:
encoding the first sequence of bits to generate a fourth sequence of bits;
encoding the second sequence of bits to generate a fifth sequence of bits;
generating a sixth sequence of bits by interleaving the fourth and fifth sequences of bits; and
padding the sixth sequence of bits with a seventh sequence of bits.

16. The apparatus of claim 1, wherein the generation of the sequence of modulation symbols comprises performing quadrature phase shift keying (QPSK) modulation of the third sequence of bits.

17-49. (canceled)

50. A wireless node, comprising:
at least one antenna;
a processing system configured to:
generate a plurality of parity bits by at least encoding a plurality of data bits;
generate a first sequence of bits comprising M repetitions of the data bits;
generate a second sequence of bits comprising N repetitions of the parity bits;
generate a third sequence of bits based on the first and second sequences of bits;
generate a sequence of modulation symbols based on the third sequence of bits; and
generate a frame comprising the sequence of modulation symbols; and
an interface configured to output the frame for transmission via the at least one antenna.

51. An apparatus for wireless communication, comprising:
a processing system configured to:
receive a frame comprising a sequence of modulation symbols;
generate a first sequence of bits based on the sequence of modulation symbols;
generate M sequences of bits based on the first sequence of bits;
generate N sequences of bits based on the first sequence of bits;
generate a second sequence of bits based on the M sequences of bits;
generate a third sequence of bits based on the N sequences of bits;
generate data bits by at least decoding the second sequence of bits based at least on the third sequence of bits.

52. The apparatus of claim 51, wherein the generation of the first sequence of bits comprises demodulating the sequence of modulation symbols.

53. (canceled)

54. The apparatus of claim 51, wherein the processing system is further configured to generate a fourth sequence of bits and a fifth sequence of bits by de-interleaving the first sequence of bits, wherein the M sequences of bits are based on the fourth sequence of bits, and wherein the N sequences of bits are based on the fifth sequence of bits.

55. The apparatus of claim 54, wherein the processing system is further configured to generate a sixth sequence of bits by decoding the fourth sequence of bits, wherein the M sequences of bits are based on the sixth sequence of bits.

56. The apparatus of claim 55, wherein the decoding of the fourth sequence of bits comprises performing a one-time pad decryption of the fourth sequence of bits.

57. (canceled)

58. The apparatus of claim 54, wherein the processing system is further configured to generate a sixth sequence of bits by decoding the fifth sequence of bits, wherein the N sequences of bits are based on the sixth sequence of bits.

59. The apparatus of claim 58, wherein the decoding of the fifth sequence of bits comprises performing a one-time pad decryption of the fifth sequence of bits.

60. (canceled)

61. (canceled)

62. The apparatus of claim 51, wherein each of the M sequences of bits are based on data bits.

63. The apparatus of claim 51, wherein each of the N sequences of bits are based on parity bits.

64. (canceled)

65. The apparatus of claim 51, wherein the processing system is further configured to generate the second sequence of bits by performing a maximum ratio combining (MRC) of the M sequences of bits.

66. The apparatus of claim 51, wherein the processing system is further configured to generate the third sequence of bits by performing a maximum ratio combining (MRC) of the N sequences of bits.

67. The apparatus of claim 51, wherein the processing system is configured to generate a fourth sequence of bits by appending a fifth sequence of bits to the second sequence of bits, wherein the generation of the data bits comprises decoding the fourth sequence of bits based on the third sequence of bits.

68. The apparatus of claim 51, wherein the generation of the data bits comprises performing a low density parity check (LDPC) decoding of the second sequence of bits.

69-109. (canceled)
